(19) United States
(12) Patent Application Publication
(10) Pub. No.: US 2025/0037885 A1
(43) Pub. Date: Jan. 30, 2025

(54) FUSION REACTOR

(71) Applicant: James M. Cleeves, Emerald Hills, CA (US)

(72) Inventor: James M. Cleeves, Emerald Hills, CA (US)

(21) Appl. No.: 18/613,264

(22) Filed: Mar. 22, 2024

Related U.S. Application Data
(60) Provisional application No. 63/491,938, filed on Mar. 23, 2023.

(51) Int. Cl. G21B 1/05; G21B 1/15

(52) U.S. Cl. CPC G21B 1/05; G21B 1/15

(57) ABSTRACT

The fusion reactor includes a vacuum chamber configured to contain a reaction region of spiraling ions and electrons. An injector is configured to inject a first reactant ion species into the vacuum chamber, and a second injector is configured to inject a second reactant ion species into the vacuum chamber. Solenoid magnets are configured to control reactant ion motion in the vacuum chamber to overlapping spiral paths. The velocity difference between ions of the first reactant ion species and ions of the second ion reactant species is sufficient to cause a fusion reaction between ions of the first reactant ion species and the second reactant ion species during a collision. A collection apparatus is configured to harvest energy released during the fusion of ions of the first reactant ion species and the second reactant ion species.

### CROSS-REFERENCE TO RELATED APPLICATION

This application claims priority to U.S. Provisional Patent Application No. 63/491,938, filed Mar. 23, 2023, titled “FUSION REACTOR”, the contents of which are hereby incorporated by reference in its entirety.

### BACKGROUND

Fusion reactions on the sun go forward very slowly, at approximately 15 million degrees Celsius, which is the equivalent of about 13,000 volts of electrical potential. Even at that energy, an individual hydrogen (H) ion takes eons to finally react with another to form helium (He) and release energy. By increasing the energy of the H ion, it can be made to react much more quickly, even at the reduced pressures available in earthbound fusion reactors. Most earthbound reactors try to contain a ˜100-million-degree Celsius plasma at a small fraction of an atmosphere pressure for a few seconds, to allow the H to tunnel through the strong nuclear force barrier around its neighbor and react to form He and a neutron while releasing a large amount of energy. Currently, most reactors are designed to use a majority of that released energy to supply the energy required to sustain an ongoing reaction.

Previously, it has been found that, when ions are caused to collide with sufficient energy, they can react almost immediately. Colliding beam reactors take advantage of this phenomenon. One challenge associated with current reactor designs is the limited number of opportunities for the beams to interact, and the resultant extremely low probability of a collision happening.

Colliding beam reactors have been previously proposed in which the beams of ions are recirculated, so that they have multiple opportunities to collide. One challenge that has been encountered is that any collisions which do not result in fusion can knock an ion off track and essentially slow it down. The closing velocity between ions must be optimized for each reaction considered, and when the ions are slowed, they are no longer moving at the velocity needed for the highest probability of fusion. However, colliding beam reactors have a desirable aspect in that they don't rely on a self-regenerating plasma. Instead, when the beam supply is turned off, the reactant supply stops, and the energy generation stops. There is no danger of a runaway reaction.

Particle beams in a magnetic field will have a characteristic radius of gyration around the magnetic field lines. The radius is proportional to the velocity, mass and charge on the particle. This effectively enlarges the beam diameter and lowers its effective density. Worse, the phase of that spiral motion could ensure that particles traveling at a matching radius could never collide.

The probability of a successful fusion collision is a function of the particle energy. It has a peak at a specific energy, but it is a continuous function. Lower or higher energies have less probability to react. For reactions that require high energies to obtain that optimum probability, the power needed to accelerate the particles to that reaction energy makes it difficult to harvest net energy out of the system. Operating the system at less than optimum reaction energy allows for net power output at the cost of longer containment time needed.

Deuterium and triton (the nucleus of tritium) are isotopes of hydrogen that are easiest to react with each other, to form helium (He). Unfortunately, most of the energy that is generated in that fusion event is put into a neutron. The neutron is not controllable with an electric or magnetic field, and when it collides with a solid to release its energy thermally, it can make that solid radioactive. Lifetimes for this radioactivity are relatively short, for example approximately a dozen years, but it is still a health hazard for everyone involved.

Provided herein are, inter alia, solutions to these and other problems in the art.

### BRIEF SUMMARY

An example implementation of the subject matter described herein is a fusion reactor with the following features. The fusion reactor includes a vacuum chamber configured to contain a reaction region of spiraling ions and electrons. An injector is configured to inject a first reactant ion species into the vacuum chamber, and a second injector is configured to inject a second reactant ion species into the vacuum chamber. Solenoid magnets are configured to control reactant ion motion in the vacuum chamber to overlapping spiral paths. The velocity difference between ions of the first reactant ion species and ions of the second ion reactant species is sufficient to cause a fusion reaction between ions of the first reactant ion species and the second reactant ion species during a collision. A collection apparatus is configured to harvest energy released during the fusion of ions of the first reactant ion species and the second reactant ion species.

In another, interrelated aspect, a method for causing ions to spiral on magnetic field lines within a fusion reactor is provided. The method includes injecting, via one or more first injectors, a first reactant ion species into a vacuum chamber of the fusion reactor, and injecting, via one or more second injectors, a second reactant ion species into the vacuum chamber, wherein the first reactant ion species and the second reactant ion species have overlapping spiral paths, and wherein the energies are sufficient to cause an overtaking velocity is sufficient to cause a fusion reaction between the first reactant ion species and the second reactant ion species. The method further includes sweeping the magnetic field lines relative to an injection line of the first reactant ion species and the second reactant ion species, wherein a high density ion species path is broadened; and forming a magnetic field in a magnetic bottle, the magnetic bottle configured to constrain only the first reactant ion species and the second reactant ion species, and to allow a product ion species into an energy recovery module.

In some variations, one or more of the following features may optionally be included in any feasible combination.

The first reactant ion species can be Boron and the second reactant ion species can be proton. The first reactant ion species can be deuterium and the second reactant ion species can be deuterium. A deuterium-deuterium reaction can result in production of ionized helium-3 and triton at energies that keep the new product ions on a path which continues to intersect the original injected deuterium beams, to create a second set of product ions and a significantly larger total energy output. The fusion reactor can be designed to collect energy from high energy helium ions, high energy protons, and high energy neutrons in a mix of direct and thermal energy extraction. The fusion reactor can be designed to collect energy from high energy helium ions, high energy protons, and high energy neutrons using thermal energy extraction. The reactor can be optimized to react at least a portion of a product of an initial deuterium-deuterium reaction with the injected deuterium ions to form helium, hydrogen, and neutrons. The first reactant ion species can be deuterium and the second reactant ion species can be Triton. The first reactant ion species can be Deuterium and the second reactant ion species can be ³He. Operating conditions can be chosen to optimize net power output. An energy of the Boron ion species can be approximately 3.64e5 volts. A voltage or voltages can be chosen to generate a velocity difference of approximately 6.7e6 meters/sec between the Boron and proton. The diameter of the vacuum chamber can be configured such that fusion-generated helium ions are circulated in the magnetic field and do not hit the wall even after coulomb scattering.

A plurality of electrostatic plates can be used in a low magnetic field region to direct the product ion species into a direct electrical conversion module. The method can further include sweeping an electron removal foil through the beam of the first reactant ion species at a velocity high enough to prevent overheating and charge crowding. The electron stripping foil can include gold leaf. The method can further include electrical and magnetic shielding of the first reactant ion species and the second reactant ion species and the one or more first injectors and the one or more second injectors. A relative motion of the magnetic fields and the one or more first injectors and the one or more second injectors can be optimized for a maximum fusion yield with a minimum ion beam power. The method can further include placing a plurality of electron injectors such as to distribute them through the spiraling ions. Electrons can be injected at a sufficiently low energy to avoid radiation losses. Electrons can be injected at an angle that is approximately normal to the magnetic field lines, such that the electrons are also retained by contractions of the magnetic fields. The method can further include choosing an absorber position configured to maintain a collection radius outside a sweep of the reactant ion species spirals. The method can further include adjusting a ratio of the magnetic fields to match a voltage of the energy absorber. The spiraling ions that collide with an inside absorber can remain in the fusion reactor, while the spiraling ions that are at a lower angle and have sufficient energy to pass the magnetic field pinch can escape out of the fusion reactor. The method can further include adjusting the electron injection angle to maintain an approximately neutral cloud of spiraling ions. Electrons and the first reactant ion species and the second reactant ion species can be injected at an angle relative to the magnetic field lines that will ensure retention of spiraling ions due to the ratio of magnetic fields in a pinched region versus a reaction region. In some implementations, injecting by the first injector or the second injector includes generating an injector magnetic field by the first injector or the second injector. The injector magnetic field is opposite of a magnetic field within the vacuum chamber. A null zone is generated at a tip of the first injector or the second injector by the injector magnetic field.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1A is a graph of fusion reaction cross-sections. The graph shows particles having equal momentum, and illustrates the cross-section in Millibarns as a function of the energy of the light particles in KeV for the following particle pairs: deuterium/triton (DT), deuterium/deuterium (DD), deuterium/³Helium (D+³He), proton/¹¹Boron (p+¹¹B), and proton/⁶Lithium (p+⁶Li).

FIG. 1B is another graph of fusion reaction cross sections. The graph illustrates the cross-section in square meters as a function of the center-of-mass energy in keV for the following particle pairs: deuterium/triton (D−T), deuterium/deuterium (Total D−D), deuterium/³Helium (D−³He), proton/¹¹Boron (p−¹¹B), and ³Helium/³Helium (³He−³He).

FIG. 2A shows the paths taken by particles that have a coulomb collision and deflect from their original path by 15 degrees. The smaller circle represents a particle that deflects 15 degrees along the length of the magnetic field line. It has a lower velocity normal to the line because of momentum conservation to it spirals in a smaller radius circle. The other two trajectories show if a particle is deflected 15 degrees normal to the field line. The velocity is the same, but the center of the spiral is offset.

FIG. 2B shows how the initial injection of the beams can be moved relative to the magnetic field lines so that a cylinder of large effective wall thickness can be formed. In this way a large fraction of deflected ions can remain in contention for fusion collisions.

FIG. 3 is a schematic representation of a direct energy conversion apparatus. It shows injectors for both reactants, proton (p+) and boron (B+5), as well as electron injectors. It shows the spiral path of the ions and the pinched magnetic field lines used to contain both the reactant ions and the injected electrons. The electron trajectory is also a tight spiral, but the diameter is too small to show at this scale. Superconducting solenoid magnets used to generate the magnetic fields are shown. A simple schematic of the direct energy conversion electrode is shown. The cooling of the direct energy conversion electrode is not shown, for simplicity. The heat absorbed by the cooling would be run into a turbo-machinery-based-generator, also not shown for simplicity. The collector becomes biased to the energy available in the product helium (He). Three example product He ion trajectories are shown. One trajectory comes off of the reaction at a high angle and hits the collection electrode surrounding the reaction zone. Two other trajectories are shown coming off of the reaction at angles low enough that they can travel past the magnetic pinch regions. The energy from the products following these two trajectories is captured in the low magnetic field region outside each end of the reactor.

FIGS. 4A-4B show the relationship between particle energy and the probability of reaction on the right axis and particle energy translated into collision velocity on the left axis. FIG. 4A shows a closer view of the operating conditions described in the text. FIG. 4B shows higher probability regions requiring acceleration of the ions to higher velocities.

FIG. 5 shows plant output power for both thermal-only and thermal-plus-direct conversion versus accelerating voltage. Also shown is the reaction probability at that condition.

FIG. 6 shows the paths for a deuterium-deuterium (D−D) fueled reaction. The deuterium is initially injected at two different energies. This is seen in the two thick-walled paths. They overlap for about half of the small diameter path. ³He and triton (T) will be formed from D−D collisions, and those orbits are shown. ³He and T orbits intersect the original D orbits, and a secondary reaction of D−³He or D−T can happen there.

FIG. 7 shows the path of the high energy He overlaid onto the two initial ion paths. The energy difference is sufficient to cause most of the He to traverse a path outside of the paths of the earlier reactant particles. Collector electrodes are placed outside the reactant paths and inside the high energy He and p+ product paths.

FIG. 8 shows additional screen electrodes use to constrain low angle intermediate energy ³He and T ions formed during the initial D−D reaction.

FIG. 9 is a schematic representation of the magnetic field lines of a reactor consistent with implementations of the current subject matter.

FIG. 10 is a schematic representation of a pole piece, ion path and field cancelation zone of a reactor consistent with implementations of the current subject matter.

FIG. 11 illustrates the ion path through the injector as view 90 degrees to the view in FIG. 10. This shows the ion path first turned by the injector magnetic field, the transition through the field cancelation zone and the subsequent path in the main reactor consistent with implementations of the current subject matter.

FIG. 12 illustrates another example implementation of the magnetic field at the tip of the injector, consistent with the implementations of the current subject matter.

FIG. 13 illustrates a closer view of a bend between two straight sections of a path of a reactor consistent with implementations of the current subject matter.

FIG. 14 illustrates a wider view of a bend between two straight sections of the path of a reactor of FIG. 13.

FIG. 15 illustrates an exemplary closed loop of a reactor consistent with implementations of the current subject matter.

FIGS. 16A-16B illustrate additional exemplary bend portions of a path of a reactor consistent with implementations of the current subject matter.

FIGS. 17A-17D illustrate models of potential injectors consistent with implementations of the current subject matter. These models include heatmaps and vectors maps that are best viewed in color.

### DETAILED DESCRIPTION

As noted above, currently available fusion reactors suffer from several challenges, including those associated with radioactive residue. Implementations of the current subject matter provide a reactor that can optionally use reactants whose products have no radioactive residue. In some example implementations, tens of megawatts of electrical output may be generated from a reactor that is approximately the size of a basketball court.

A fusion reactor consistent with the description herein generates a large recirculating beam of reactants. It is difficult to aim particles at each other accurately enough to achieve sufficient collision. As described herein, a solution to increase the collision rate can include creating a cloud or wide beam of target particles and injecting reactant ion species into the cloud or wide beam to increase the chances of collisions, such as fusion collisions. The recirculation of both reactants (for example, a first and a second ion species) in the beamline allows for billions of opportunities for collisions to happen in hundredths of a second. This is enough to ensure that fusion reactions will happen. Both reactants and products are ions and are controlled by a magnetic field along the axis of the machine. Because the reaction products have a high energy compared to the reactants, products can be allowed to transition a barrier that is too high for the reactants to cross. Reactants can be continuously supplied to the reaction chamber while the products are continually drawn off for energy extraction, neutralization and removal. For example, in one implementation, the reactor can convert the product ion energy directly into high voltage direct current. In another implementation, the reactor can convert the kinetic energy of the products into thermal energy to be converted to electricity in conventional turbomachinery. Electrons can also be supplied to the reaction chamber, to minimize the repulsive forces between ions. Electrons are not consumed in the reaction and could be supplied at a different rate.

Losses in the system are minimized because the velocity of the particles are only a few percent of the speed of light. Acceleration rates are low and minimal radiation losses are incurred.

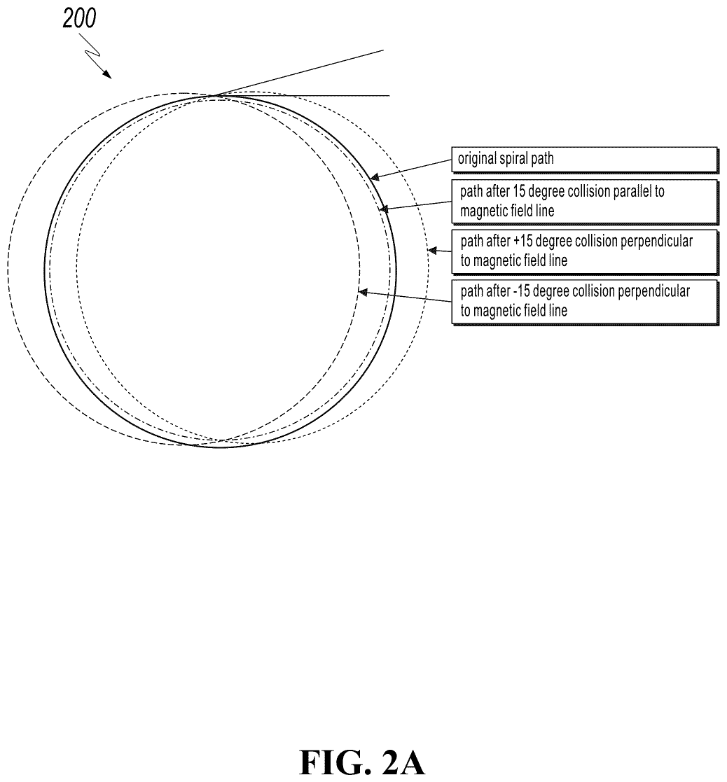

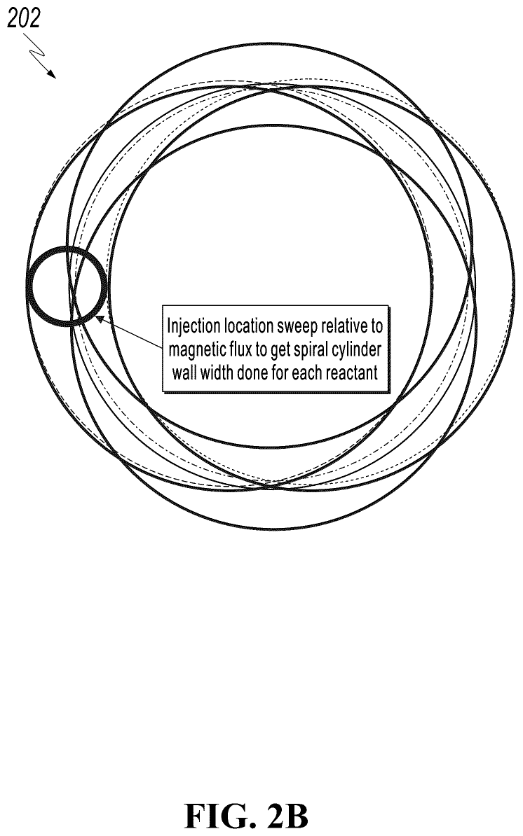

A fusion reactor includes a cylindrical chamber evacuated to extremely low background pressure. Strong magnetic fields are formed inside the chamber by superconducting solenoid coils outside the chamber. Two reactant ion beams are injected at a nearly normal angle to the magnetic field lines in the chamber, at energies that will cause the two different beams to have the same characteristic radius of gyration around magnetic field lines. Electrons are also injected near normal to the magnetic field lines, so they are trapped in the same volume as the ions. The ions and electrons move away from the injection site due to a gradient in the magnetic field. The injection sites are moved relative to the magnetic field lines to give the resultant cylinder of spiraling ions a desired wall thickness. An example of this effect is illustrated by the ion paths 202 illustrated in FIG. 2B. Each ion type has a different mass to charge ratio. The different mass to charge ratio requires that one type of ion move at a much higher velocity than the other to maintain the same characteristic spiral radius. This difference in velocity is chosen to be high enough to result in a fusion reaction at a chosen probability level. The ion beams are set to chase each other down the same spiral path along the magnetic field line. The electron beams have a much smaller radius and are set to spiral inside the ion beam wall width. At a position a distance away from the injection site the magnetic field is again increase to a maximum and forms an end stop for the injected ion and electron flux. In this way the ions are trapped to spiral around the magnetic field line in a magnetic containment that forces the ion paths to be very close to each other. Even if ions are not injected normal to the magnetic field lines, the magnetic containment forces them to a near normal path as the beam line fills with additional reactants. The presence of a near equal amount of negative charge from the electrons in the region largely eliminates the repulsion forces pushing the ion paths apart. Fusion collisions result in particles that have much higher energy than the injected ions. They also spiral in the magnetic field, but because their energy is much higher, their radius is outside that of the reactants. The ratio of magnetic field strength between the pinch regions and the body of the reactor is determined by the collection voltage and position of the absorbers. Helium (He) ions that come off in a direction that is at a high angle to the magnetic field are captured inside the reaction zone, those that come off at a lower angle have enough energy to move past the magnetic end cap. Among other possible options, the collection region can be designed to absorb the energy of the high velocity particle to form heat to run a turbine and can include a high voltage electrostatic collector to turn the charged particle energy into electric power directly, or the like. Once the high energy He particles formed in the reaction have been neutralized in the energy collection hardware, the resultant neutral He is pumped out of the reactor. If the reaction results in neutron production the reaction chamber becomes part of the energy collection hardware. If the reaction doesn't produce neutrons, essentially all the produced energy is collected in dedicated absorbers.

Deuterium and tritium can be reacted in this way. Each require removal of a single electron to form the desired ion. Required acceleration voltages for this reaction are relatively low. These two attributes of the reaction make it desirable since conventional ionizers and accelerators are adequate. The downside is the reaction makes both He and high energy neutrons. Energy needs to be recovered from both and the neutrons damage the vessel and make it radioactive.

TABLE 1
Initial deuterium beam set up.

| | |
|---|---|
| Deuteron | Deuteron |

| | | | | | |
|---|---|---|---|---|---|
| 9.00E+04 | volts accel | | | 5.00E+05 | volts accel |
| 1.70E−27 | kg is one amu or mass of proton | | | 1.70E−27 | kg is one amu or mass of proton |
| 1.60E−19 | coulombs is electron charge | | | 1.60E−19 | coulombs is electron charge |
| 2 | amu is mass of second D | | | 2 | amu is mass of second D |
| 2 | amu of 1st D | | | 2 | amu of deuteron |
| 90000 | voltage of accelerator | | | 500000 | voltage of accelerator |
| 3.00E+08 | m/s = speed of light | | | 1 | charge state of D |
| 1 | charge state of D | | | qE = 1/2 mv2 | v2 = qE/1/2m |
| qE = 1/2mv2 | v2 = qE/1/2m | | | proton | |
| B | | | | 6.86E+06 | velocity of particle in meters per second |
| 2.91E+06 | paricle velocity in m/s | | | 2.3% | ratio of particle velocity to speed of light |
| 0.97% | speed ratio to speed of light | | | 1.50E+07 | temperature of the sun |
| 3.95E+06 | Chasing velocity | 1.82E+09 | degree equivalent | 89.9999700 | degree p + angle to magnetic field lines |
| 89.9999738 | b deg angle to magnetic axis | | | 1.571 | radians p+ |
| 1.571 | radians B | | | 1.000 | sin of p + angle |
| 4.56853E−07 | cos of radians B | | | 1.82E−02 | meter radius for proton |
| 1.000 | sin of radians B | | | 1.816 | cm radius for proton |
| 0.771 | cm radius for B spiral | | | 6.01E+07 | rotational frequency of proton |
| 6.01E+07 | rotational frequency of boron | | | 5.98E−06 | cm precession per revolution p+ |
| 2.21207E−06 | cm precession per revolution B | | | 16.152 | meter long reaction zone for D rotations through T |
| | m/s p through B | | | 5.98 | meter long reaction zone for T rot |
| 0.100 | barns = fusion cross section | | | | |
| 6.02E+23 | molecules at 1 atm stp | 2.24E+01 | Liters stp | | |
| 760 | torr at 1 atm | 2.6875E+19 | atoms per cm3 at stp | | |
| 0.432 | torr - tokamak run at 0.7 torr at 1e8 degrees | | | | |
| 1.52814E+16 | atoms per cm3 at operating pressure | | | | |
| 1E−28 | one barn in m2 | | | | |
| 1E−24 | 1 barn = 10e−24 cm2 | | | | |
| 1.52814E−09 | probability/centimetermeter of pass through | 2.48E+05 | atoms/cm length | | |
| 6.54E+06 | meters to prob of 1 | 4.03026E−06 | cm distance between ions | | |
| 4.50 | sec to get D distance through D if only half circle is overlapped | | | | |

| 8.02551 | |
|---|---|
| tesla - ITER uses 13 tesla | |
| for 0.7 torr effective, the | |
| 5.236E−07 | cos p + radians |
| mass × velocity/charge × tesla | |
| 2.3570226 | radius ratio |
| 0.37018077 | ratio of reactor length re [symbol] |
| 5.20E−08 | gram/cm3 boron density at effective pressure |
| (probability of an event) = fusion cross section * t [symbol] | |
| 1.48E+00 | p + atom spacing ratio |

[symbol]

indicates data missing or illegible when filed

TABLE 2
Continuation from Table 7.

| | | | |
|---|---|---|---|
| 50 | amps D beam current | | |
| 3.13E+20 | electron per second or protons per second | | |
| 3.13E+20 | ions per second if have a charge of 1 | 2.04E+04 | cm3/sec at magnetic field density |
| 50.00 | D beam current to match T atom injection rate - assumes both are lost at same rate | | |
| 1.6E−19 | joules equals 1 eV | | |
| 2.00E+07 | D-D + D-He3 + D-T fusion energy | | |
| 3.2E−12 | joules per B fusion | 1 | watt equals 1 J/sec |
| 8.00E+08 | joules per second | | |
| 80% | % that don't get ricocheted out of contention | | |
| 40% | combined cycle power plant eff. Ar turbine top cycle, steam bottom | | |
| 800 | megawatts fusion energ [symbol] | 320 | MW elec out thermal plant |
| 80% | cyclotron eff with superconducting LC circuit - my guess | | |
| 0.30 | ion accelerator efficiency from Harms is .3 from Linlor .8 | | |
| 9.3.E−02 | megawatts to run magnets | | |
| 1.2.E−01 | megawatts plant power requirement for other stuff | | |
| 31 | megawatts Deuteron beam power with super cyclo | | |
| 6 | mega watts Low energy D beam with super cyclo | 51.79 | deg He direction |
| 90% | direct conversion efficiency | 0.904 | radians |
| 302 | output with spiral track and super cyclo on both beams | 2 | charge on He |
| | | 4 | mass of He |

| Calculate how much beam preloading would be required to cover a +/− 15 deg deflection | | | |
|---|---|---|---|
| 7.03E−05 | cm2 focused beam area cm3/sec/cm/sec | | |
| 4.73E−03 | cm injected B beam radius at magnetic field | | |
| 0.73 | cm +/− 15 deg radially deflected beam width - graphic solution | | |
| 77 | number of beam widths to equal the width of deflected trajectory | | |
| 933 | seconds to fill cylinder to cover 15 deg normal deflection | | |
| 11.4 | circumfrence of nominal beam tube | | |
| 7.9 | full circumference to 2 pass throughs | | |
| 1207 | overlap to circumfrence without extra width | | |
| 3.50E+06 | He energy | 1.41E+07 | Mev neutron energy |
| 1.81E+07 | m/s He velocity | 6.0% | |
| 1.43E+07 | velocity perpendicular to field line | | |
| 3.78E−02 | meter radius | | |
| 3.78 | cm radius for high energy He | | |
| 13 | 11 cm is radius of product He - chamber needs to be bigger | | |

[symbol]

indicates data missing or illegible when filed

The Boron-proton reaction gives less total energy, but it does not generate neutrons in the reaction. Unfortunately, the peak reaction probability is much higher and there are 5 electrons to strip from the B to enhance the reaction probability with the proton. The energy required to collide the two particles at optimum reaction probability uses up a large fraction of the released energy. The efficiency of the accelerators and the power conversion equipment quickly consumes all the available energy and make the system energy negative. Operating at lower voltages reduces both the energy required and the probability of a reaction. Low reaction probability is overcome by containing the reactants longer and increasing the effective beam area to include particles that are bumped out of their initial orbit by elastic coulomb collisions.

Magnetic fields required to get the desired particle density require superconducting solenoid coils. The same super-conduction is desirable for the ion accelerating equipment. Accelerators run in a superconducting resonant condition lose very little energy to unrecoverable loses. Low loses in the accelerating equipment are required for highest net power.

Instead of recirculating the reactants around a circular vessel to provide collision opportunities, both reactants are made to spiral around the same magnetic field lines. The difference in velocity between them is advantageously configured to provide a collision velocity sufficient to generate a fusion reaction. The fusion products have much higher energy and so spiral around a larger path and can then be pulled off for energy extraction.

### Example Implementation 1

The disclosed reactor uses a magnetic bottle to contain ions that are forced to follow specific paths. This is different from currently known magnetic bottle confinement reactors that use high temperature plasma with random ion motion.

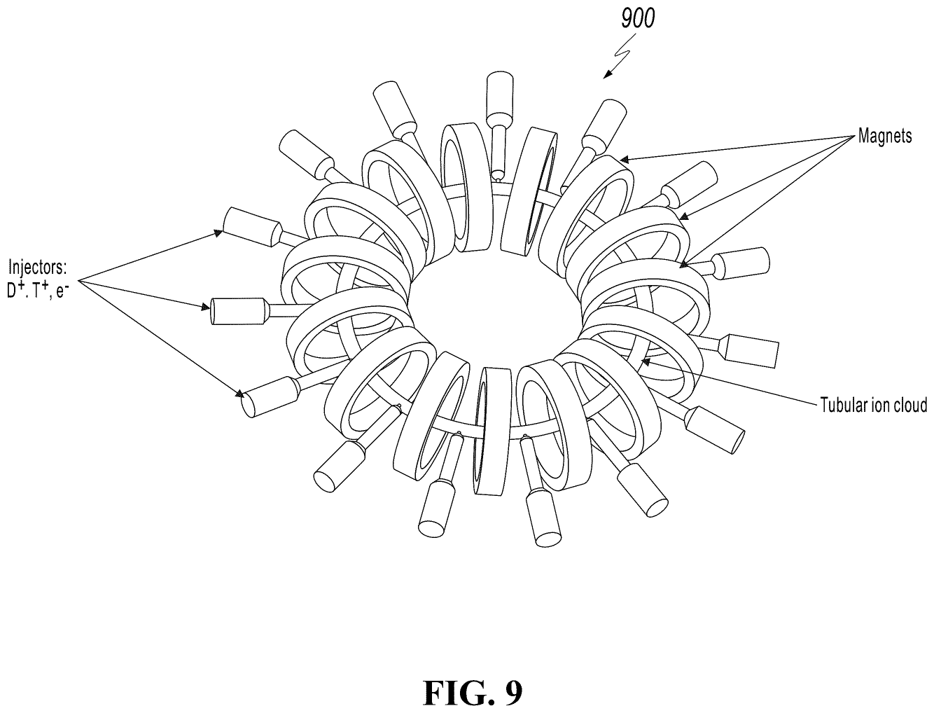

Currently known magnetic bottle confinement reactors containing a high energy plasma have been shown to suffer plasma leakage through the end caps that is too significant to successfully maintain the plasma. It is expected that, using a reactor as described and illustrated herein, the spiral motion of the ions and electrons will mitigate much of the potential loss from the magnetic bottle. However, there is a large electrostatic force that tends to push the ions apart. If the spiral motion is not sufficient to give the magnetic field the necessary leverage to maintain the ions and electrons, a loop reactor can be used. For example, a Tokomak style vessel would have no end caps through which ions could escape. This would minimize ion loss before the fusion reaction but would also require that all direct conversion electrodes and thermal collection surfaces be located inside the reactor. Additionally, the products of the fusion reaction would have to be pumped away through ports in the reactor wall. For example, if the reaction of choice is a deuterium-tritium reaction, tritium generated by neutron bombardment of lithium inside the reactor would need to be pumped out through ports in the reactor wall. In a reactor such as that described and illustrated herein, the need for electrons to be added to the reactor can be reduced or even eliminated due to the fact that the loosely sealed ends of a linear reactor are eliminated in the disclosed design. Thus, the electrostatic force pushing the ions apart is constrained by the endless loop created by the loop reactor. Electrons may be necessary in either style reactor to maintain the radius of the spiral by countering the space charge pushing ions to a larger spiral. FIG. 9 shows an example of a loop reactor 900 having colliding spiral ion beams constrained by magnetic field in an ultra-high vacuum. The injectors are shown, along with magnets and the tubular ion cloud created.

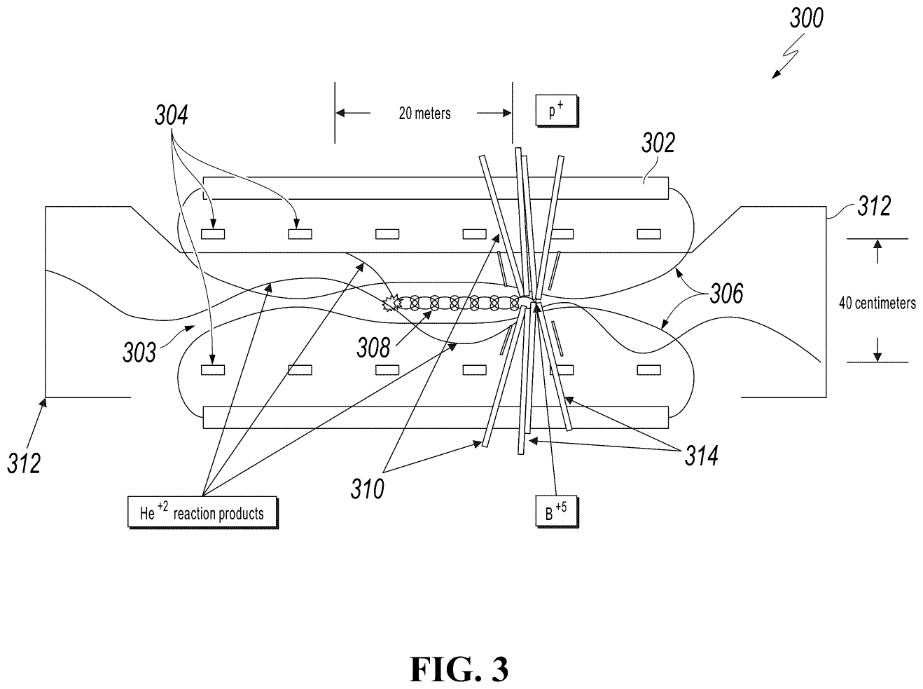

In an implementation illustrated in FIG. 3, a tube 302 of approximately 20 meters length and 40 cm inside diameter is formed. The tube 302 defines a chamber 303. Multiple vacuum pumps (not shown) are attached to remove non-reactive species. Solenoid magnets 304 are spaced along the outside of the chamber such that a strong magnetic field 306 can be supported inside the reaction chamber 303. The magnetic field 306 strength is managed in a way that largely contains the ions 308 in a magnetic bottle. Peak magnetic fields 306 are chosen to be extremely high, but they are set to be decreasing intensity from where the ions and electrons are injected towards the center of the reactor. The decreasing field forces the reactants away from the injector 310 to avoid collisions. Boron ions, electrons, and protons are injected at the same radius from the centerline of the magnetic field. They are injected at different velocities. The velocities are chosen so that the ions orbit the same magnetic field lines at the same radius. The difference in speed is enough so that the chasing ion can fuse during a collision with the slower moving ion. The particle density is maintained by a second high magnetic field region at about 15 meters down the reactor from the injection site. The magnetic field lines increasing density in the region reflect the particles back toward the injection end of the reactor. In this way the density of particles continues to increase as the injectors continue to inject ions. The density of the particles increases reducing the time required for the particles to collide in a fusion reaction. The physical position of the injectors 310 relative to the magnetic field lines 306 can be moved such that the resulting ion orbits look like a thick-walled cylinder when viewed on end, similar to FIG. 2B. Electrons are injected so that they spiral within that thick wall region. Conversely the solenoid coils 304 can be moved relative to the ion injectors 310. This is done so that the ions 308 that are scattered by coulomb collisions largely still remain in a region of high particle density. The relative motion of the two can be optimized to deliver the highest yield for the lowest input power. Coulomb collisions are largely elastic, so the particles retain sufficient velocity to fuse when they finally do collide directly with the other reactant. Once a proton hits a boron with sufficient velocity to fuse, three He⁺² ions are produced at high energy. The high energy of the He causes them to orbit the magnetic field at a much larger radius than the reactants, so they only minimally interact. Their energy is high enough and their orbit radius is large enough that they can impinge on a collector 312 that is inside the reactor 300, but outside the radius of the reactants. Products that come from the reaction site at low angles are not stopped by the magnetic field 306 crowding and leave the reaction zone. Once past the high magnetic field region, the ions 308 are either allowed to impinge the wall of a beam dump where their energy is turned into heat, or they are directed to an electrode where their kinetic energy is turned into a direct current voltage without the intermediate mechanical to electrical energy conversion. Once the He⁺² has impacted either style of energy recovery, the He⁺² is neutralized and needs to be pumped away to keep it from cluttering the ongoing reactions.

Solenoid magnets are used to cause the ions to spiral. The choice of accelerating voltage on each species determines the radius. Where the ions get injected determines where the spiral stays in space. The mass charge ratio is what determines the radius for a given particle velocity.

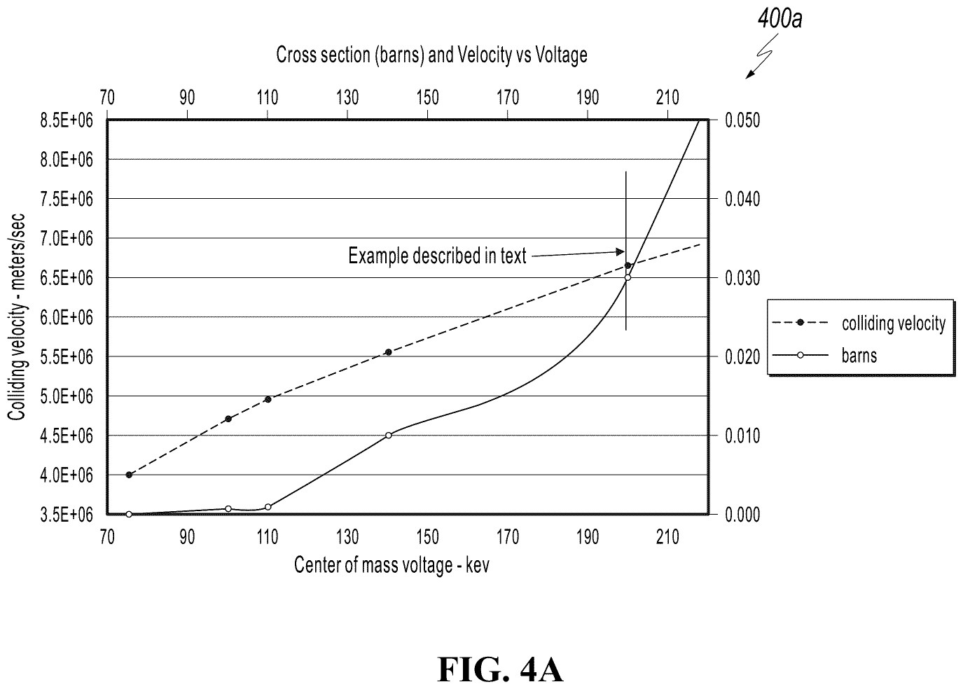

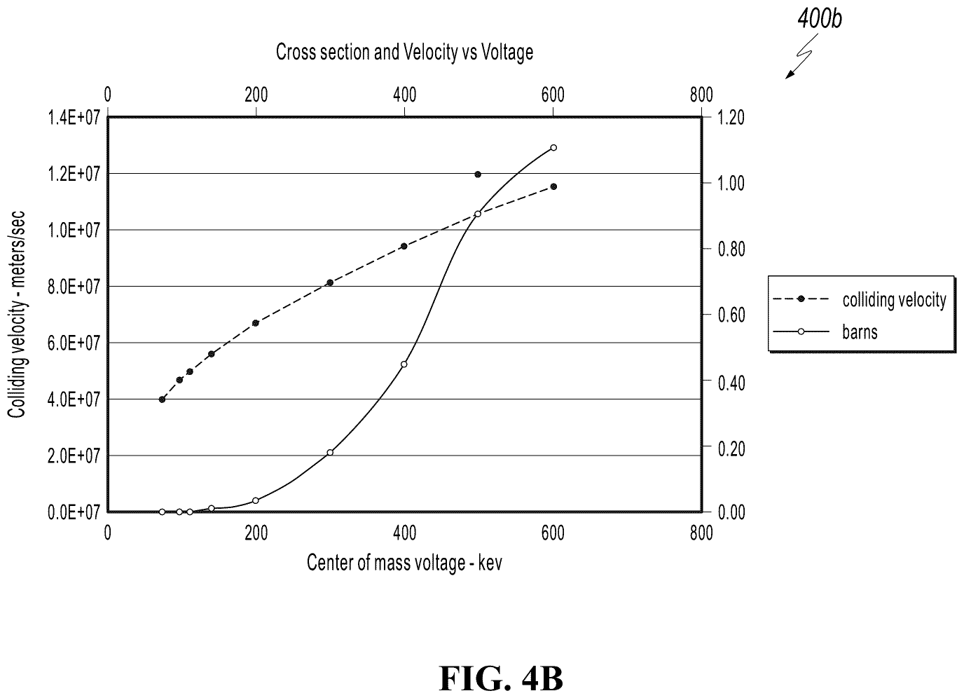

For example, boron could be injected at 3.6e5 volts, protons could be injected at 8e5 volts. Electrons could be injected at 1e3-5e3 volts. The magnetic field at the injection site could be just under 13 tesla, as used in the International Thermonuclear Experimental Reactor (ITER), decreasing to 8 tesla in the body of the reactor and increasing to 13 again approximately 15 meters away. Ions 308 are injected at close to 90 degrees to the magnetic flux lines 306 and would all have a gyration radius of 1.51 cm. The proton would be traveling 6.7e6 m/s faster than the boron and the cross section for reaction at that speed is approximately 0.03 barns. FIGS. 4A-4B show charts 400a and 400b that illustrated the conditions described within this example. The solenoid magnets 304 can be moved in a 0.3 cm orbit around the outside of the vacuum system to distribute the ions into a 0.6 cm wide band. The ions can track in a 3.2 cm diameter cylinder where the thickness of the wall of that cylinder would be 0.6 cm. This is done so that most of the coulomb collisions will result in trajectories that are within that band. It would take about 625 seconds at 10 amperes of protons at a +1 charge state to develop to steady state. In some implementations, the pre-load of the beam line are protons because for the same number of possible targets in the ion cloud, there can be ⅕th as many coulombs of charge. Each proton only carries 1 positive charge, and each electron has 1 negative charge. One boron has 5 positive charges and so would need 5 electrons to neutralize it.

In order to get the ions 308 to the correct injection location, each beam needs to be shielded from the magnetic field as well as the electric field for example, by the shields 314. The particles will be deflected as soon as they enter the high field regions of the reactor. An example of such deflected particle paths 200 are illustrated in FIG. 2A. Shielding 314 can extend until very near the desired spiral radius. The spiral radius of the electrons is so small that they will need to be divided into many different beams distributed around the distribution of the ions 308. In General, all of the ion species need to be charged as they enter the magnetic field of the reactor so that their motion can be controlled. In some implementations, the reactant beams can be neutral as they traveled to the reactor, and then go through electron stripping just before the injector.

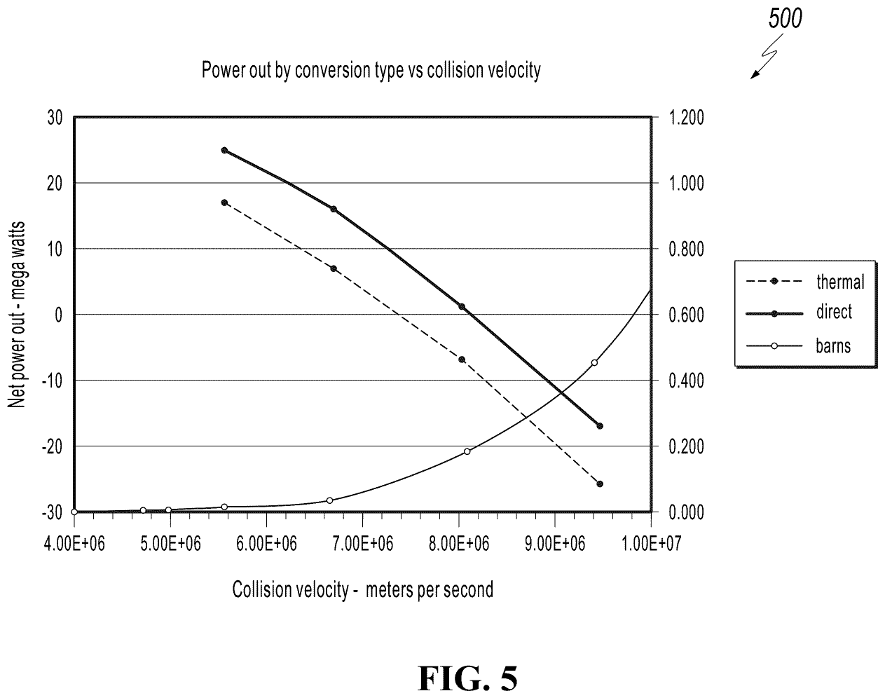

FIG. 5 shows chart 500 that illustrates the relationship between conversion type, collision velocity, and net power generation. Boron with a +5 charge would be injected at 50 amps and the products would yield approximately 70 Megawatts of energy. A superconducting accelerator, either linear or cyclotron, would be used so that accelerator efficiency could be high. At 80% assumed accelerator efficiency the power required to accelerate the proton would be approximately 10 megawatts, the boron would consume 23 megawatts. Generating boron at a +5 charge would consume 1 megawatts. After subtracting power to supply the superconducting solenoids 304 and other users, the net output for a thermal plant at 60% combined cycle efficiency would be 7 megawatts. Under the same conditions listed above, the output from a direct conversion of the He energy would be a plant output of 23 megawatts.

TABLE 3
Assumptions and calculated output from the p + boron reaction described in the specification.

| | |
|---|---|
| Boron | Proton |

| | | | | | |
|---|---|---|---|---|---|
| 3.64E+05 | volts accel | | | 8.00E+05 | volts accel |
| 1.70E−27 | kg is one amu or mass of proton | | | 1.70E−27 | kg is one amu or mass of proton |
| 1.60E−19 | coulombs is electron charge | | | 1.60E−19 | coulombsis electron charge |
| 11 | amu is mass of B with 5 protons and 6 neutrons | | | 11 | amu is mass of D with 1 protons and 1 neutrons |
| 1 | amu of proton | | | 1 | amu of proton |
| 363637 | voltage of accelerator | | | 800000 | voltage of accelerator |
| 3.00E+08 | m/s = speed of light | | | 5 | charge state of B from reaction rate chasing sheet |
| 5 | charge state of b | | | qE = 1/2 mv2 | |
| qE = 1/2 mv2 | v2 = qE/1/2m | | | v2 = qE/1/2m | |
| B | | | | proton | |
| 5.58E+06 | particle velocity in m/s | | | 1.23E+07 | velocity of particle in meters per second |
| 1.86% | speed ratio to speed of light | | | 4.1% | ratio of particle velocity to speed of light |
| 6.69E+06 | Chasing velocity | 2.62E+09 | degree equivalent | 1.50E+07 | temperature of the sun |
| 89.9999700 | b deg angle to magnetic axis | | | 89.9999763 | degree p + angle to magnetic field lines |
| 1.571 | radians B | | | 1.571 | radians p+ |
| 5.23599E−07 | cos of radians B | | | 1.000 | sin of p + angle |
| 1.000 | sin of radians B | | | 1.52E−02 | meter radius for proton |
| 1.516 | cm radius for B spiral | | | 1.516 | cm radius for proton |
| 5.86E+07 | rotational frequency of boron | | | 1.29E+08 | rotational frequency of proton |
| 4.98775E−06 | precession per revolution B | | | 3.94E−06 | cm precession per revolution p+ |
| 6.69E+06 | m/sp through B | | | 15.4 | meter long reaction zone for p + rotations through boron |
| 0.030 | bams = fusion cross section | | | 9 | meters to get the equal number of B ions |
| 6.02E+23 | molecules at 1 atm stp | 2.24E+01 | Liters stp | | |
| 760 | torr at 1 atm | 2.6875E+19 | atoms per cm3 at stp | | |
| 0.463 | torr - tokamak run at 0.7 torr at 1e8 degrees | | | | |
| 1.63753E+16 | atoms per cm3 at operating pressure | | | | |
| 1E−28 | one barn in m2 | | | | |
| 1E−24 | 1 bam = 10e−24 cm2 | | | | |
| 4.91258E−10 | probability/centimeter of pass through | | | 2.54E+05 | atoms/cm length |
| 2.04E+07 | meters to prob of 1 | | | 3.93844E−06 | cm distance between ions |
| 3.0 | sec to get p + distance through boron | | | 2.42E+06 | ions in each loop |

| | | | | 8.6 | tesla - ITER uses 13 tesla for 0.7 torr effective, they say |
|---|---|---|---|---|---|
| | | | | 100 | ITER MW for auxiliary stuff |
| 6.25E+18 | electrons per coulomb | | | 80 | ITER MW electrical for magnets |
| | | | | 830 | ITER meters cubed plasma volume |
| 1 | charge state of proton | | | 0.70 | ITER torr pressure in plasma |
| | | | | | MW guess at this plant aux power ITER = 100 MW |
| | | | | 13 | tesla field in ITER |
| 1.04E−19 | mv perp B | | | 1400 | cubic meters for vacuum chamber |
| 2.09E−20 | mv perp P | 5.00E+00 | perp mv ratio | 1.25 | bigger to get to magnets? |
| | | | | 1750 | magnetic volume? |
| | | | | 40 | cm inside dia of magnet |
| | | | | 1.94 | meters cubed magnetic volume |
| | | | | 0.09 | megawatt magnet power for reduced volume |
| | | | | | same field as ITER |
| | | | | 0.1108394 | megawatts to run the facility |
| 4.1361E−07 | cos p + radians | | | 20 | initial spiral angle |
| mass × velocity/charge × tesla | | | | 0.3490659 | |
| 0.99999953 | radius ratio | | | 0.3420201 | sin of initial angle |
| | | | | 4.20E+06 | m/s velocity towards endplate |
| | | | | 9.36E+04 | volts required to just hold back |
| | | | | 3.26 | cm precession of initial ions |
| | 0.6 | | | | |
| 3.06E−07 | gram/cm3 boron density at effective pressure | | | | |
| (probability of an event) = fusion cross section * target density * distance | | | | | |
| 1.00E+00 | p + atom spacing ratio | | | | |
| 1.26642652 | B atom spacing ratio | | | | |

TABLE 4
Continuation of assumptions and calculations to support the p + boron reaction described in the specification.

| | | | |
|---|---|---|---|
| 50 | amps B beam current | | |
| 3.13E+20 | electron per second or protons per second | | |
| 6.25E+19 | ions per second if have a charge of 5 | 3.82E+03 | cm3/sec at magnetic field density |
| 10.00 | proton beam current to match boron atom injection rate - assumes both are lost at same rate | | |
| 1.6E−19 | joules equals 1 eV | 6.25E+19 | protons/sec |
| 8.70E+06 | B fusion energy 8.7 MeV | | |
| 1.392E−12 | joules per B fusion | 1 | watt equals1J/sec |
| 6.96E+07 | joules per second | | |
| 80% | % that don't get ricocheted out of contention | | |
| 60% | combined cycle power plant eff. Ar turbine top cyde, steam bottom | | |
| 69.60 | megawatts fusion energ | 41.76 | MW elec out thermal plant |
| 80% | cyclotron eff with superconducting LC circuit - my guess | | |
| 0.30 | ion accelerator efficiency from Harms is .3 from Linlor .8 | | |
| 8.9.E−02 | megawatts to run magnets | | |
| 1.1.E−01 | megawatts plant power requirement for other stuff | | |
| 10 | megawatts proton beam power with super cyclo | | |
| 23 | mega watts boron beam with super cyclo | 54.4 | deg He direction |
| | | 0.949 | radians |
| 7 | output with spiral track and super beams cyclo on both | 2 | charge on He |
| 90% | direct conversion efficiency | 4 | mass of He |
| 16 | megawatts out with direct conversion | | |
| 1.17E−06 | kg/secboron per beamline | | |
| 36.9 | kg/year boron usage | | |
| 202295 | kg/yr for half the US population residential supply | 10 | megawatt hours per year per household |
| 0.01% | of worlds yearly production | 130809 | megawatt hours per year per system direct convert |
| | B 11 is 80% of naturally occuring B | 5.00E+06 | bay area population |
| 11212 | households per beamline | 147 | systems needed in bay area for all household needs |
| 320 | million people | 4.00E+06 | tons of boron produced per year |
| 2.6 | people per household | | |
| 5489 | systems needed for half the US households | | |
| 1 | coulomb/second = 1 amp | 6.25E+18 | electrons/sec for 1 amp |
| | proton meters per second around spiral at | | |
| | ions per second if have a charge of | | |
| | electron | | |
| 1.00E+04 | accel voltage | 9.251918687 | cm2 area of outer circle |
| 9.11E−31 | kilograms mass of electron | 5.441559918 | |
| 5.93E+07 | m/s electron velocity | 3.810358769 | cm2 area of donut |
| 5.0000000 | degree e- angle to magnetic field lines | 6.23723E+16 | ions in torus cross section 1 cm long |
| 0.087 | radians e- | 5.91E+07 | eelctron current to run straight down neutral torus |
| 0.087 | sin of e- angle | 5.91E+05 | megawatts |
| 3.42E−06 | meter radius for electron | 60% | electron accelerator efficiency |
| 0.000 | cm radius for electron | 1 | megawatts to just match steady state currents |

| Calculate how much beam preloading would be required to cover a +/− 15 deg deflection | | | | |
|---|---|---|---|---|
| 6.84E−06 | cm2 focused B beam area cm3/sec/cm/sec | | | |
| 1.48E−03 | cm injected B beam radius at magnetic field | | | |
| 0.61 | cm +/− 15 deg radially deflected beam width - graphic solution | | | |
| 205 | number of beam widths to equal the width of deflected trajectory | | | |
| 625 | seconds to fill cylinder with p + to cover15 deg normal deflection | | | |
| 7.31E+06 | 315 amps per cm2 at 50 amps and 0.001 tesla magnetic field | | | |
| 1000 | cm/sec gold leaf velocity past low density charge | | | |
| 1.00E−05 | cm gold leaf thickness: | | | |
| 3.15E+04 | amps/cm2 current density out the edge of the gold leaf into the carrier | | | |
| 250000 | volts to get ions out of source into accelerator | | | |
| 1 | charge state into electron stripper | | | |
| 2.07E+06 | m/s into electorn stripper | | | |
| 0.75 | megawatts to run B ion stripper | | | |
| 40 | amps out from stripper, 10 amps at + 1 charge state −> 40 amps for other 4 electrons | | | |
| 3.76E+06 | 3rd He energy | | 2.46E+06 | low energy He from reaction |
| 1.88E+07 | m/s He velocity | 6.3% | 1.52E+07 | 5.1% % speed of light |
| 1.53E+07 | velocity perpendicular to field line | | 1.24E+07 | |
| 3.78E−02 | meter radius | | 3.06E−02 | |
| 3.78 | cm radius for high energy He | | 3.057 | for lower energy He |
| 12 | 11 cm is radius of product He - chamber needs to be bigger | | | |
| 9.53 | circumfrence of nominal beam tube | | | |
| 7.85 | full circumference to 2 pass throughs | | | |
| 3227 | overlap to circumference without extra width | | | |
| 6.57E+10 | | | | |

Generating boron at a +5 ionization state could be done by passing a boron with a +1 state though gold leaf, or other suitable metal, at approximately 0.1 micron thickness to strip the additional 4 electrons. This is a high energy high current operation and would heat the gold rapidly. To control the temperature of the gold it would be placed on a rotor that would allow it to be passed through the beam continuously, but the time exposed to the beam would be short enough to keep the temperature and the charge build up under control. Moving the gold leaf through the beam at greater than 1000 cm/second would keep the current density in the gold in the 3e4 amps per cm² range. This could be done on a rotor that was set up to dissipate the current generated. The electron stripping operation could be done either between the boron +1 generator and the high voltage accelerator or preferably between the accelerator and the injector.

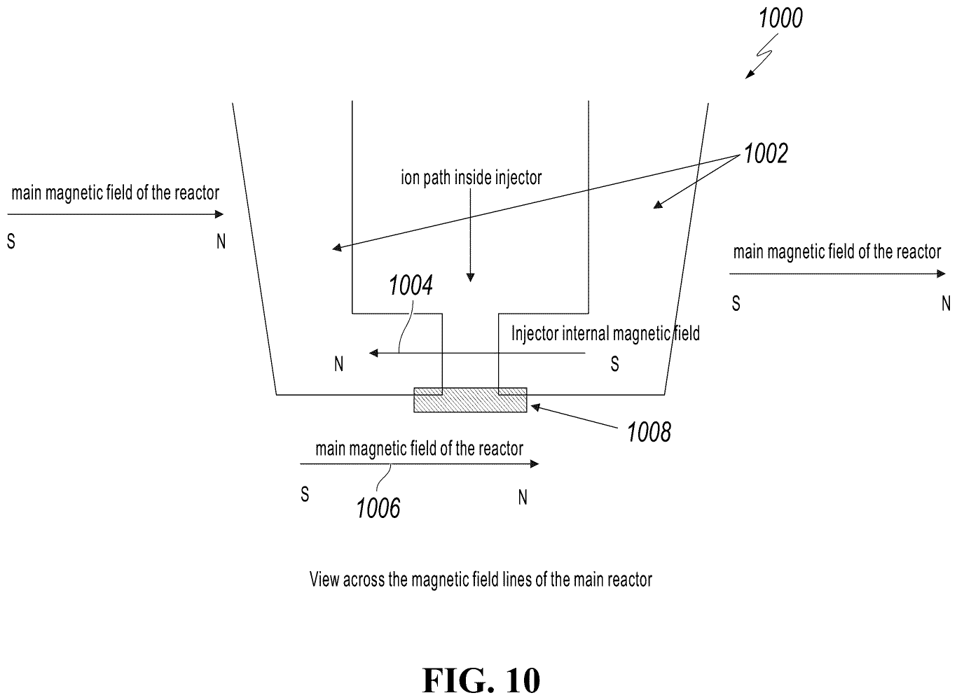

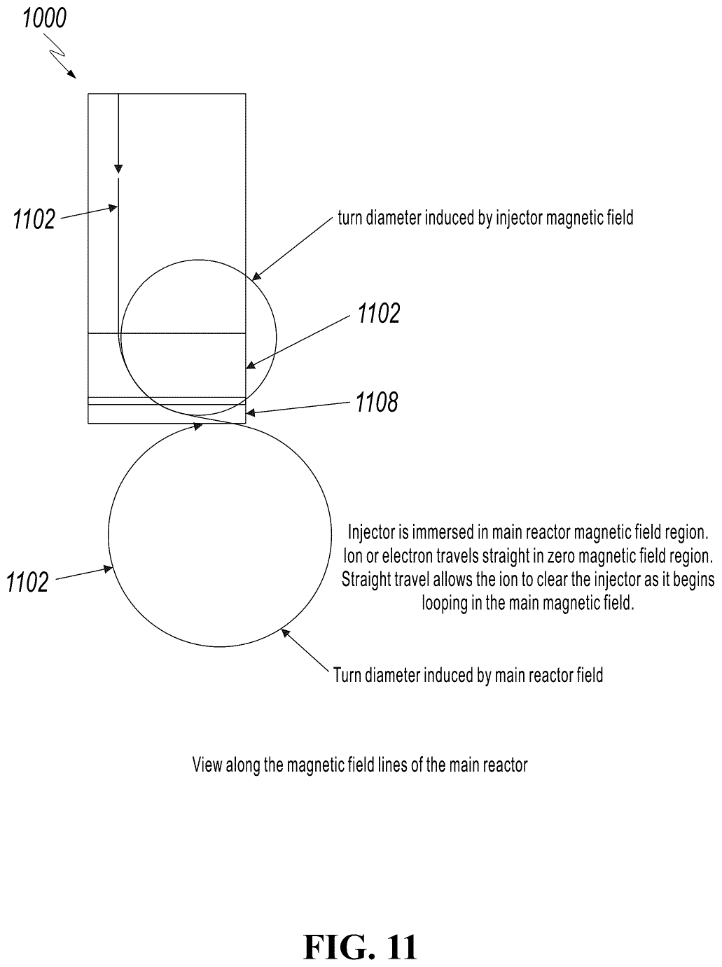

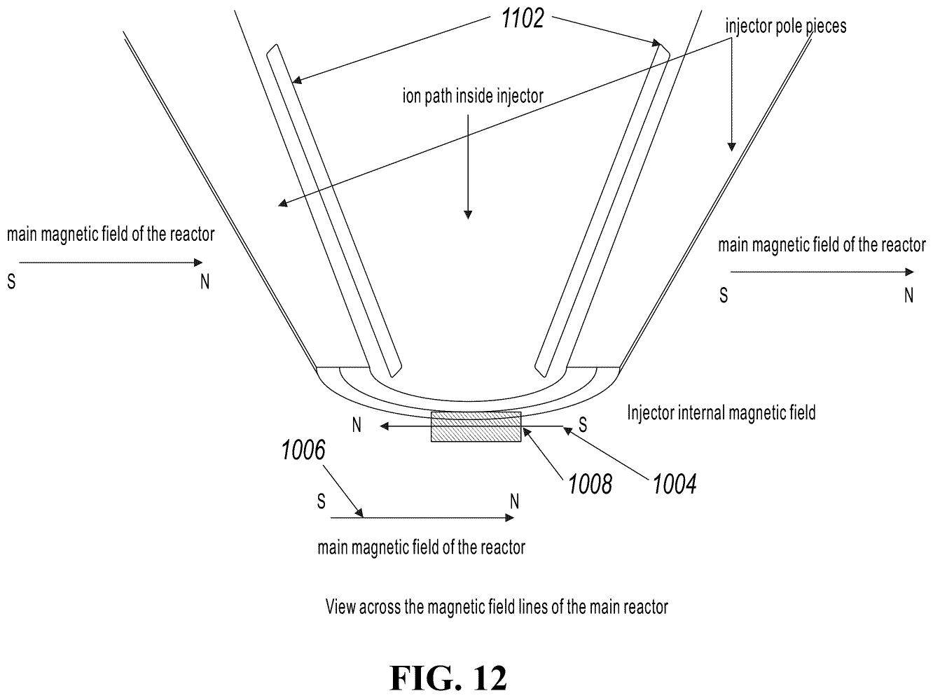

As described, injection of ionized particles into the magnetic field region of the reactor requires a specially designed injector. If the ion emerges from the magnetically shielded injector directly into the magnetic field, the ion is likely to strike the injector as it completes its first loop under the influence of the reactor's magnetic field. The ion's momentum is not enough to carry it deep into the magnetic field before it begins to loop at a radius defined by the ion's momentum and the strength of the magnetic field. A possible method for extending the travel distance of the ion away from the injector could involve providing a region of little to no magnetic field as compared to the main reactor magnetic field. For example, this may be achieved by introducing a strong magnetic field near the exit point of the injector tip, the strong magnetic field having a polarity opposite to the main reactor magnetic field. Thus, between the strong magnetic field near the exit point of the injector tip and the now distorted main reactor magnetic field, there will be a region where these magnetic fields cancel each other, providing a region where the ion can travel in a straight line. The magnetic fields and initial ion direction can be managed such that the ion carries a velocity component away from the injector for a distance large enough that the ion can clear the injector as it begins to loop in the main reactor magnetic field. Additionally, pole pieces can be used to introduce a remotely generated magnetic flux to the necessary location near the injector tip. FIG. 10 illustrates an example injector tip 1000 that can be used with aspects of this disclosure. The injector 1000 includes two injector poles 1002 one having a N polarity and one having a S polarity. The poles 1002 are arranged to produce an injector magnetic field 1004 in an opposite direction of the reactor magnetic field 1006. With such an arrangement, the injector 1000 produces a null zone 1008 where the injector magnetic field 1004 and the reactor magnetic field 1006 cancel one another out. The null zone 1008 allows any injected ions to exit the injector 1000 and into the reactor. and FIG. 11 illustrates a side view of an injection path 1102 of an ion as it reacts to the magnetic fields of the main reactor and the injector 1000. As the injected ion passes the injector poles 1102, a turn diameter is induced in the injection path 1102 by the poles 1102. As the injected ion exits the injector 1000, the ion enters the null zone and proceeds on a straight path until being influenced by the reactor magnetic field, which induces rotation into the cylinder of spiraling ions of a desired wall thickness previously described FIG. 12 illustrates another implementation of an injector 1200. The injector 1200 is substantially similar to the injector 1100 previously described with the exception of any differences described herein. As shown in FIG. 12, the shape and shielding 1102 inside the injector 1102 force the countering injector magnetic field further into the main reactor field 1006. This produces a larger null zone 1008, allowing the ion to penetrate further into the reactor before the ion path is curved by the reactor magnetic field 1006.

Using a beam dump concentrates the thermal energy into a relatively small volume that can easily be allowed to run at temperatures up to or equal to peak combustion temperatures of a gas turbine. This in turn leaves the turbine outlet temperature similar to the traditional gas turbine outlet temperature. This energy can then be harnessed by a bottoming cycle, just as the highest efficiency power plants do today.

The thermal side could use a monatomic gas as the working fluid for a gas turbine. Argon (Ar), for instance, could be compressed in a turbo compressor before being cycled through the beam dump to absorb the energy. The hot Ar would then be expanded through a turbine driving both the compressor and electrical power generator. The hot effluent from the turbine would then be used to boil a high-pressure liquid. The liquid would turn to vapor and the vapor would then be used to run a second turbine or generator, to extract more electrical power. The Ar would be routed back to the compressor inlet and the Rankine turbine exhaust would be routed through a cooling loop to bring it back to a liquid state.

The direct conversion could be accomplished by using high voltage electrodes to deflect the ions out of a low magnetic field region outside the reactor. Once out of the magnetic field, ions travel in a straight line and can hit the collection electrode at near normal incidence. At normal incidence their full momentum can be dissipated crossing the collector electrode's electric field. In this way the collector electrode can be charged to near the energy of the particles and supply the load with the full He beam current at very high DC voltage. He is generated at 2.4 MeV and 3.76 MeV. The power levels mentioned above were calculated based on the collector being held at 2 MeV. The difference in energy between the collector voltage and the arrival voltage of the He ion would also be available to heat a working fluid for either a smaller turbomachinery system or for process heating. Either way, cooling requirements for the total system are significantly reduced by using the direct conversion approach.

High energy He that comes from the fusion site could go in any direction. Those that go more normal to the magnetic field travel in large radius orbits but cannot pass by the magnetic field constriction because they don't have enough energy directed along the axis of the reactor. These large orbit particles can impact an absorber placed outside the paths of the reactants. The absorber can be held at a voltage consistent with the arrival angle of the ion. For instance, for a 2.4 MeV He, the absorber might be held at 2 MeV. A particle traveling at an angle of about 55 degrees to the magnetic field line would still have 2 MeV energy normal to the absorber and would collide. It would deposit both the 0.4 MeV of kinetic energy and 2 MeV of charge to the absorber. So both heat and direct electrical power would be extracted from this electrode in the reaction chamber. Particles with a smaller angle would have enough energy to pass the magnetic constriction and deposit their energy in an absorber outside the reactor. The ratio of the maximum magnetic field at the constrictions to the field in the reaction zone determines the angle of the ions that can escape vs not. This is set based on optimization of the direct electrical conversion absorber voltage and the leakage of reactants past the constriction.

A cyclotron can be used to accelerate ions for this reactor. Beam voltage is relatively low compared to modern high energy particle accelerators. A moderate diameter cyclotron could be used, but the design would be unique to produce the large beam currents required. The reactor does not require continuous beams, the intermittent bursts from a cyclotron are adequate. Attaching a large inductor in between the Dees of the cyclotron would allow the machine to be run in a resonant condition. If the whole system was made superconducting, the losses at resonance would be minimal. The remaining resistance in the system and the acceleration of the ions inside the system would provide the needed damping.

The operating voltages will be optimized once the efficiency of the accelerators is known. Higher voltages give higher probability for successful fusion, at the cost of extra power consumed to produce the higher voltages.

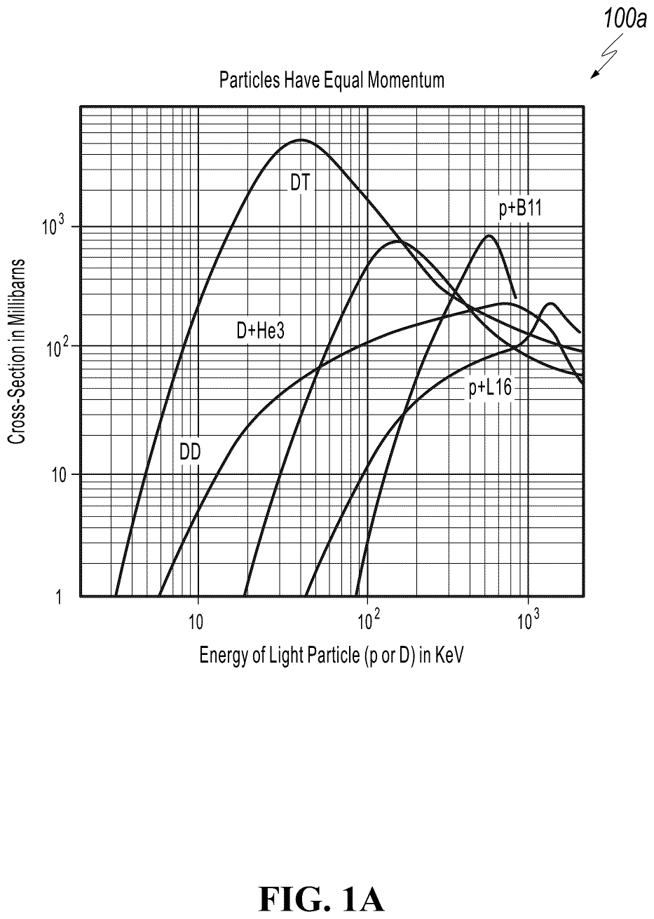

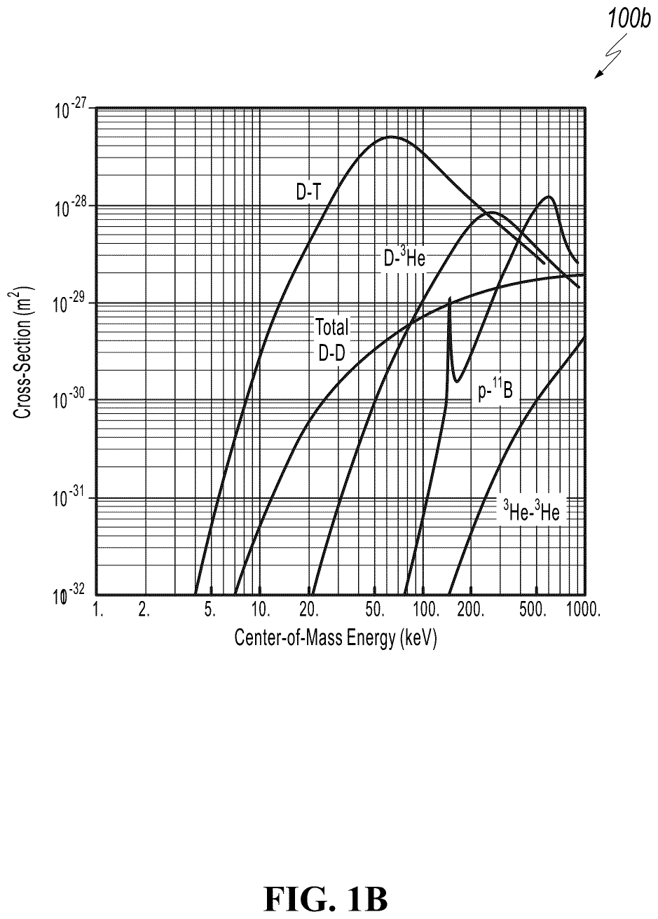

Fusion probabilities are known as a function of the collision energy of two particles moving in opposite directions with equal momentum. FIG. 1A is a chart 100a that can be used to determine what energies are needed to match momentum between different particles. FIG. 1B is a similar chart 100b measuring slightly different properties to determine momentum. Generally, the probabilities increase from zero to a peak and then decrease as the voltages increase still further. Knowing the energy required in volts, you can convert directly to velocities. You can generate a curve for probability vs collision velocity. In the system where the beams are made to chase each other, you first determine the collision velocity that gives you an acceptable cross section, not necessarily the maximum. Once you know the required chasing velocity needed, you can trade off the voltage on the particles to result in two conditions being met. First: the chasing velocity gives the desired fusion cross section and second: the gyration radius around a magnetic field line is equal. These two conditions can be met with many different operating conditions, the optimum is chosen to maximize the system net output.

Background gas is a contaminate that can cause collisions with the reactants due to the long dwell times in the vacuum system. In the case of the proton boron reaction, the reaction chamber does not see energetic particle bombardment, except for in the beam dump or the direct energy converter. Liquid He will already be used in the plant to enable the solenoids to super conduct. It will likely also be used for superconducting accelerators. It can also be used to hold the chamber walls at that temperature and the walls can be coated with high surface area coatings like activated charcoal so that the walls themselves become very high conductivity pumps. When the time comes to regenerate the wall surfaces, the magnetic field can be reduced to allow small numbers of high energy He ions to heat the surface to allow outgassing.

Neutralized He products are also contaminants. But magnetic fields and electrostatic fields can be used to control the He while it is still ionized. In this way it can easily be moved through a low gas conduction region before being neutralized. Once in this physical trap region, the neutralized He can be pumped before it can migrate back into the reaction zone.

In the Deuterium Tritium system, the power levels are 10× the proton-boron (p+ B) system with the same maximum current from the accelerators. The D−T system also emits most of its energy in neutrons. Likely the magnetic solenoids will have to be outside the neutron energy absorbers to maintain them at superconducting temperature. This will mean larger diameter magnets than the B-p+ system, but their power consumption is still moderate because the required length for the D−T reaction is substantially less. The system is not constrained to the boron-proton reaction. But this version is constrained to reactants with dissimilar charge to mass ratios. Without the differing charge to mass ratio, you cannot generate the difference in velocity at the same gyration radius. Deuterium-triton would work well and be quite energy productive, but at the expense of having to deal with the neutron thermal energy capture and the radioactivity generated. Deuterium and ³He would also work, but you need to run the D−T reaction to produce ³He from the neutron production. Deuterium-Li also has some paths that result in neutron generation causing radioactivity. A Deuterium-Deuterium (equal charge and mass) reaction can be constructed by offsetting the center of the gyrations so that a portion of the circumference of the wide cylinder wall overlaps with the different energy deuterium cylinder.

Deuterium can be made to react with another Deuterium to form either ³He+a high energy neutron or form Tritium with a high energy proton. The odds are approximately 50-50 as to which gets formed. The ³He will carry an energy of about 0.8 MeV and the neutron will have an energy of about 2.45 MeV. The triton will have an energy of about 1 MeV and the proton of about 3 MeV.

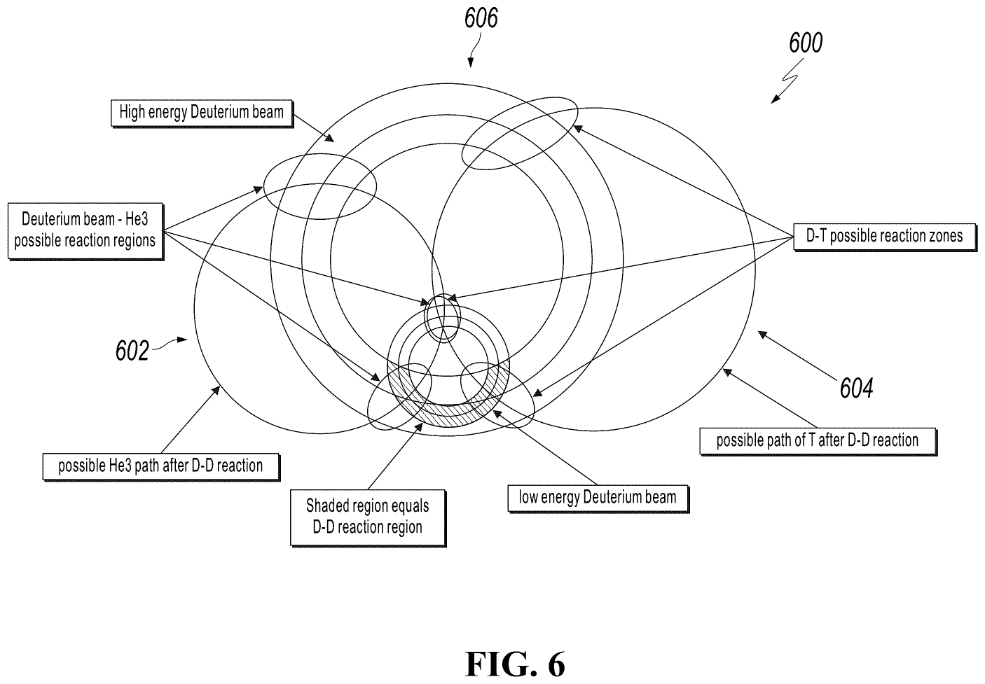

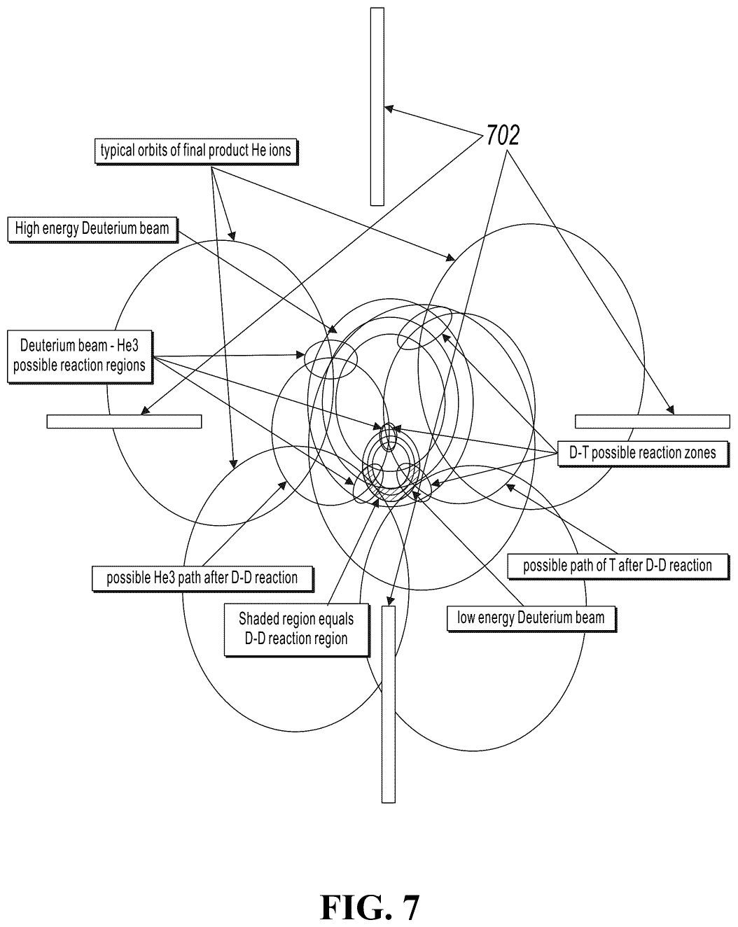

Since there is no difference between mass and charge on the deuterium, the collision velocity needed is obtained by having gyration radius of much different size. Overlap of the resulting clouds of these different speed deuterons is obtained by offsetting the center of the rotation. The wide beam wall is formed in the same way where the injection locations are swept relative to the magnetic field lines. Offsetting the beam axis reduces the total overlap, but it can be made so that the reduction in overlap region is only about 50%. The reaction probability is still 0.1 barns for voltages similar to the p+ boron reaction at 0.03 barns and the resultant reactor is similar size to the B-p+ reactor. But the energy released from this reaction is not enough to support the accelerator power required. As shown by the gyration paths 600 illustrated in FIG. 6, fortunately, the gyration radius of the ³He 602 and the radius of the T 604 is not much larger than the D radius 606. In this way, ³He and T that are formed in the initial reaction are available to intersect with the initial D beams. Eventually both D−³He reactions and D−T reactions take place. Both reactions generate products that are either neutral or at much higher energy than the initial D−D reaction products. This allows the continued use of the energy removal techniques mentioned elsewhere. However, in this reactor, As illustrated in FIG. 7, screen electrodes 702 will need to be placed near the magnetic field pinch. These screen electrodes 702 prevent the low angle ³He and T initial products from leaving the reactor. These electrodes 702 are arranged to pull some of the charge neutralization electrons out of the reaction zone, but most electrons will be shielded from that voltage by the surrounding positive ions. The screen electrodes 702 and the collectors 302 can, in some implementations, be used interchangeably.

TABLE 5
Calculation of pinch versus reaction zone
magnetic field with plant output estimates.

| | |
|---|---|
| 1.512 | ratio of core B field to pinched B field |
| 0.813 | V perpendicular/particle velocity must be greater than this wikipedia |
| 1.000 | boron v perp to v |
| 1.000 | |
| 2.00E+06 | DC volts on direct converter - arbitrary |
| 0.81 | ratio of dc volts to low V He |
| 9.49E−01 | |
| 54.4 | degrees or greater need to stay in bottle |
| 1.5129 | b ratio needed to operate at 2000000 volts |
| 8.6 | reactor T |
| 6.25E+19 | charge per sceond from p+ |
| 3.13E+20 | charge per second from B + 5 |
| 1.25E+20 | charge per second for each He |
| 2.00E+01 | amps of each He + 2 |
| 43 | mega watts out from direct conversion (amps/2 due to charge of + 2) |
| 7.4 | mega watts into thermal from low energy |
| 14.1 | mega watts into thermal from high energy |
| 12.9 | total out of thermal plant |
| 56.06 | direct plus thermal total out |

TABLE 6
Deuterium-tritium magnetic field ratio calculation with output
enhanced by collecting He⁺² on a 2.75 megavolt DC collector
in addition to the thermal absorption of the neutron energy.

| 2.75E+06 | DC volts on direct converter - arbitrary |
|---|---|
| 7.86E−01 | ratio of dc volts to low V He |
| 9.04E−01 | |
| 51.79 | degrees or greater need to stay in bottle |
| 1.62 | b ratio needed to operate at 2750000 volts |
| 99 | megawatts out direct conversion |
| 37.5 | mega watts into thermal system |
| | from direct converter voltage delta |
| 564 | megawatts neutron heat into thermal system |
| 241 | megawatts thermal system |
| 340 | electrical megawatts |

This more complex reaction is an example of the extensions of this technology. Additionally, after the secondary reaction energy is generated, the total energy made available for each D−D reaction is more than 20 MeV whereas the D−T reaction total is 17.6 MeV. Some of this energy can be collected as direct conversion at approximately 3 MeV DC output while the rest will come out either as process heat or electricity through a thermal plant. The reaction does produce high energy neutrons leading to residual reactor radioactivity, but it does not require T or ³He to be brought outside the reactor. Deuterium is the incoming fuel and He, H₂ and neutrons are the reaction products.

TABLE 7
Example calculations for deuterium-tritium reactor.

| | |
|---|---|
| Triton | Deuteron |

| | | | | | |
|---|---|---|---|---|---|
| 6.47E+05 | volts accel | | | 9.70E+05 | volts accel |
| 1.70E−27 | kg is one amu or mass of proton | | | 1.70E−27 | kg is one amu or mass of proton |
| 1.60E−19 | coulombs is electron charge | | | 1.60E−19 | coulombsis electron charge |
| 3 | amu is mass of T | | | 3 | amu is mass of T with 1 protons and 2 neutrons |
| 2 | amu of proton | | | 2 | amu of deuteron |
| 647000 | voltage of accelerator | | | 970000 | voltage of accelerator |
| 3.00E+08 | m/s = speed of light | | | | |
| 1 | charge state of T | | | 1 | charge state of D |
| qE = 1/2 mv2 | v2 = qE/1/2m | | | qE = 1/2 mv2 | v2 = qE/1/2m |
| B | | | | proton | |
| 6.37E+06 | paricle velocity in m/s | | | 9.55E+06 | velocity of particle in meters per second |
| 2.12% | speed ratio to speed of light | | | 3.2% | ratio of particle velocity to speed of light |
| 3.18E+06 | Chasing velocity | 1.18E+09 | degree equivalent | 1.50E+07 | temperature of the sun |
| 89.9999738 | b deg angle to magnetic axis | | | 89.9999700 | degree p + angle to magnetic field lines |
| 1.571 | radians B | | | 1.571 | radians p+ |
| 4.56853E−07 | cos of radians B | | | 1.000 | sin of p + angle |
| 1.000 | sin of radians B | | | 2.53E−02 | meter radius for proton |
| 2.531 | cm radius for B spiral | | | 2.530 | cm radius for proton |
| 4.01E+07 | rotational frequency of boron | | | 6.01E+07 | rotational frequency of proton |
| 7.264E−06 | cm precession per revolution B | | | 8.32E−06 | cm precession per revolution p+ |
| 3.18E+06 | m/s p through B | | | 0.206 | meter long reaction zone for D rotations through T |
| 5.000 | barns = fusion cross section | | | 0.12 | meter long reaction zone for T rot |
| 6.02E+23 | molecules at 1 atm stp | 2.24E+01 | Liters stp | | |
| 760 | torr at 1 atm | 2.6875E+19 | atoms per cm3 at stp | | |
| 0.432 | torr - tokamak run at 0.7 torr at 1e8 degrees | | | | |
| 1.52814E+16 | atoms per cm3 at operating pressure | | | | |
| 1E−28 | one barn in m2 | | | | |
| 1E−24 | 1 barn = 10e−24 cm2 | | | | |
| 7.64068E−08 | probability/centimetermeter of pass through | | | 2.48E+05 | atoms/cm length |
| 1.31E+05 | meters to prob of 1 | | | 4.03026E−06 | cm distance between ions |
| 0.04 | secto | | | | |
| | get p + | | | | |
| | distance through boron | | | | |

| | | | | 8.03 | tesla - ITER uses 13 tesla for 0.7 torr effective, they say |
|---|---|---|---|---|---|
| | | | | 100 | ITER MW for auxiliary stuff |
| | | | | 80 | ITER MW electrical for magnets |
| | | | | 830 | ITER meters cubed plasma volume |
| | | | | 0.70 | ITER torr pressure in plasma |
| | | | | | MW guess at this plant aux power ITER = 100MW |
| | | | | 13 | tesla field in ITER |
| 3.25E−20 | mv perp B | | | 1400 | cubic meters for vacuum chamber |
| 3.25E−20 | mv perp P | 1.00E+00 | perp mv | 1.25 | bigger to get to magnets? |
| | | | | 1750 | magnetic volume? |
| | | | | 40 | cminside dia of magnet |
| | | | | 0.03 | meters cubed magnetic volume |
| | | | | 0.00 | megawatt magnet power for |
| | | | | | reduced volume same field as ITER |
| | | | | 0.00148 | megawatts to run the facility |
| 5.236E−07 | cos p + radians | | | | |
| mass × velocity/charge × tesla | | | | | |
| 0.99974237 | radius ratio | | | | |
| 0.58183287 | ratio of reactor length required | | | | |
| 7.79E−08 | gram/cm3 boron density at effective pressure | | | | |
| (probability of an event) = fusion cross section * target density * distance | | | | | |
| 2.07E+00 | p + atom spacing ratio | | | | |

TABLE 8
Continuation of deuterium-tritium reaction calculations continued from Table 4.

| | | | | | |
|---|---|---|---|---|---|
| 50 | amps T beam current | | | | |
| 3.13E+20 | electron per second or protons per second | | | | |
| 3.13E+20 | ions per second if have a charge of 1 | 2.04E+04 | cm3/sec at magnetic field density | | |
| 50.00 | D beam current to match Tatom injection rate - assumes both are lost at same rate | | | | |
| 1.6E−19 | joules equals 1 eV | | | | |
| 1.76E+07 | D-T fusion energy | | | | |
| 2.816E−12 | joules per B fusion | 1 | watt equals 1J/sec | | |
| 7.04E+08 | joules per second | | | | |
| 80% | % that don't get ricocheted out of contention | | | | |
| 40% | combined cycle power plant eff. Ar turbine top cyde, steam bottom | | | | |
| 704 | megawatts fusion energ | 281.6 | MW elec out thermal plant | | |
| 80% | cyclotron eff with superconducting LC circuit - my guess | | | | |
| 0.30 | ion accelerator efficiency from Harms is .3 from Linlor .8 | | | | |
| 1.2.E−03 | megawatts to run magnets | | | | |
| 1.5.E−03 | megawatts plant power requirement for other stuff | | | | |
| 61 | megawatts Deuteron beam power with super cyclo | | | | |
| 40 | mega watts Triton beam with super cydo | | | 51.79 | deg He direction |
| 90% | direct conversion efficiency | | | 0.904 | radians |
| 238 | output with spiral track and super cyclo on both beams | | | 2 | charge on He |
| | | | | 4 | mass of He |
| | | | | 10 | megawatt hours per year per household |
| 171562 | households per beamline | | | | |
| 320 | million people | | | | |
| 2.6 | people per household | | | | |
| 359 | systems needed for half the US households | | | | |
| 1 | coulomb/second = 1 amp | 6.25E+18 | electrons/sec for 1 amp | | |
| | proton meters per second around spiral at | | | | |
| | ions per second if have a charge of | | | | |
| | electron | | | | |
| 3.00E+03 | accel voltage | | | 23.41269285 | cm2 area of outer circle |
| 9.11E−31 | kilograms mass of electron | | | 17.05429731 | |
| 3.25E+07 | m/s electron velocity | 11% | | 6.358395537 | cm2 area of donut |
| 5.0000000 | degree e- angle to magnetic field lines | | | 9.71288E+16 | ions in torus cross section 1 cm long |
| 0.087 | radians e- | | | #DIV/0! | eelctron current to run straight down neutral torus |
| 0.087 | sin of e- angle | | | #DIV/0! | megawatts |
| 2.01E−06 | meter radius for electron | | | 60% | electron accelerator efficiency |
| 0.000 | cm radius for electron | | | 0 | megawatts to just match steady state currents |

| Calculate how much beam preloading would be required to cover a +/− 15 deg deflection | | | |
|---|---|---|---|
| 3.21E−05 | cm2 focused beam area cm3/sec/ cm/sec | | |
| 3.20E−03 | cm injected B beam radius at magnetic field | | |
| 1.01 | cm +/− 15 deg radially deflected beam width - graphic solution | | |
| 158 | number of beam widths to equal the width of deflected trajectory | | |
| 11 | seconds to fill cylinder to cover 15 deg normal deflection | | |
| 15.9 | circumfrence of nominal beam tube | | |
| 7.9 | full circumference to 2 pass throughs | | |
| 2487 | overlap to circumfrence without extra width | | |
| 3.50E+06 | He energy | 1.41E+07 | Mev neutron energy |
| 1.81E+07 | m/s He velocity | 6.0% | |
| 1.43E+07 | velocity perpendicular to field line | | |
| 3.78E−02 | meter radius | | |
| 3.78 | cm radius for high energy He | | |
| 15 | 11 cm is radius of product He - chamber needs to be bigger | | |

TABLE 9
Secondary reactions from the deuterium-deuterium initial reaction. The two chasing velocities
for each product reflect passing through the two different speed deuterium spirals.

| He3 | | | T |
|---|---|---|---|
| 8.00E+05 | volts accel | 1.00E+06 | volts accel |
| 1.7E−27 | kg is one amu or mass of proton | 1.7E−27 | kg is one amu or mass of proton |
| 1.6E−19 | coulombs is electron charge | 1.6E−19 | coulombs is electron charge |
| 3 | amu is mass of second He3 | 3 | amu is mass of second D |
| 3 | amu of T | 2 | amu of deuteron |
| 800000 | voltage of accelerator | 1000000 | voltage of accelerator |
| 300000000 | m/s = speed of light | | |
| 2 | charge state of he3 | 1 | charge state of T |
| qE = 1/2 mv2 | v2 = qE/1/2m | qE = 1/2 mv2 | v2 = qE/1/2m |
| B | | proton | |
| 1.00E+07 | paricle velocity in m/s | 9.70E+06 | velocity of particle in meters per second |
| 0.033398629 | speed ratio to speed of light | 0.03233808 | ratio of particle velocity to speed of light |
| 7.11E+06 3.16E+06 | Chasing velocities | 6.79E+06 2.84E+06 | chasing velocities |
| ~0.7 barn | 0.03 barns | ~0.5 barns | ~4 barns |
| 89.99997382 | b deg angle to magnetic axis | 89.99997 | degree p + angle to magnetic field lines |
| 1.57079587 | radians B | 1.57E+00 | radians p+ |
| 4.56853E−07 | cos of radians B | 1 | sin of p + angle |
| 1 | sin of radians B | 2.57E−02 | meter radius for proton |
| 1.99 | cm radius for He3 spiral | 2.57 | cm radius for T |

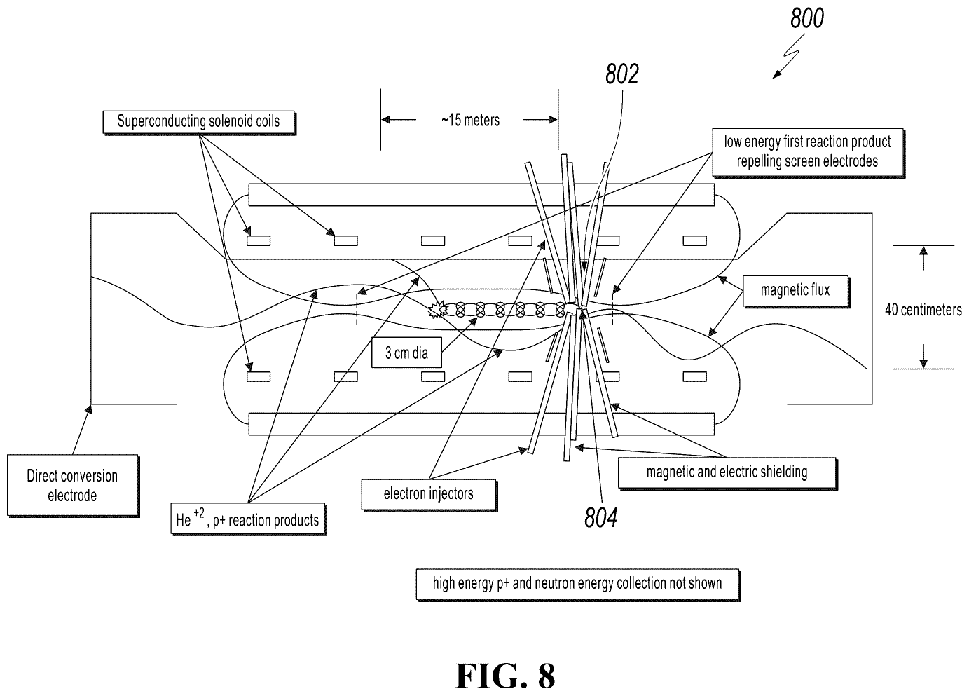

Three different accelerators are still required, two different energies of D and one additional accelerator for electrons, to neutralize the reaction zone. [0065] Such an example reactor 800 is illustrated in FIG. 8. The reactor 800 is substantially similar to the reactor 300 previously described with the exception of any differences described herein. In this example, the high energy Deuterium beam 802 is at 8e5 volts and the low energy beam is at 1e5 volts. The overtaking velocity is 5.6e6 meters/second, and at that collision velocity, the reaction probability is 0.1 barns. With half the low energy beam 804 overlapping into the high energy beam 802 path, the reactor 800 is substantially 20 meters long (plus or minus 5 meters). The ³He and T intermediate reaction products are at velocities high enough relative to the initial Deuterium beams that they have good probability to react, and they overlap the wide beam at least twice every spiral rotation.

The small size of the reactor (300, 800) lends itself to the idea of the reactor as a consumable. If the whole reactor (300, 800) and beam dump is made radioactive and materials degrade over a reasonable lifetime, for example, greater than an order of months, treat the reactor (300, 800) and beam dump replacement as scheduled maintenance items. The whole of the radioactive portion of the system could be melted into a couple cubic feet of solid that can then be encased in concrete to live out its decay time.

### Example Implementation 2

In another implementation, the fusion reactor may include injecting charged particles orthogonally into a magnetic field, as described in further detail below.

Injecting ions into a strong magnetic field is difficult due to the ions being turned in the magnetic field and then colliding with the injector hardware as it completes a loop within the magnetic field. This argument holds for uniform magnetic fields. However, the ion trajectory can be caused to drift in the presence of a field gradient. This mechanism can be used to cause the spiral ion path to drift away from the injector and allow the ion to remain inside the magnetic confinement. The gradient can be introduced by tilting solenoid coils relative to each other. This phenomenon is generally a problem to be dealt with in a tokomak reactor. Large toroidal currents are required to generate magnetic fields to counter this drift. Without the counter fields the ions would quickly spiral into the inside wall of the reactor. This is not a problem for a linear reactor where the magnetic field is symmetric around the axis. Ions can be maintained in a stable spiral inside the linear section.

Ion and electron injectors may be positioned in some or all of the bend regions between straight sections of a polygon shaped reactor. Injecting ions into the reactor may, for example, proceed according to the following sequence: ions of one species would be generated in an accelerator near the reactor. For example, at least one accelerator per charged particle type per bend may be used to supply the required currents. The beam of ions would be steered by magnetic and electrostatic means to enter the reactor at a specific point in the bend region. The specific point is where a secondary set of coils with a field equal to and opposite polarity to the main field yields a region where these two fields cancel each other. A near zero absolute field region is formed. This region would be on the outside of the bend and the ion would enter from the outside so that it would exit the zero-field region some distance in from the edge of the main reactor field. This region would be in the bend so the ion would see the field gradient due to the bend as well as the field gradient due to an imposed axial gradient. These two gradients would move the ion's circular path radially away from the injector and along the main field axis into the straight section.

The size of the counter field region is determined in combination with the particular charged particle energy and mass, the injection angle, the radial field gradient, the axial field gradient as well as the overall average field strength. Radial positioning is important so that uncompensated fields at the outside of the reactor are small enough to be compensated for by the charged particle position and injection angle. The target is to have the charged particles leave the compensated region traveling radially inward along the radial field gradient, pointed at the centerline of the main magnetic field.

More complete modeling capability could allow the ion to simply be injected directly into a gradient of the main field. This would also require balancing radial field gradient, position and angle of the ion, axial gradient, average field strength, physical size of components as well as mass and energy of the particle.

Preliminary calculations suggest that Deuterium ions at 600,000 volts could be injected in the plane of the centerlines of the two neighboring straight sections. If it was also angled at 60 degrees to the bisecting plane of the angle between the two straight sections and the angle between the straight sections was 37 degrees, the ion would then spiral and drift inward and along the main field axis. By the time it reached the end of the bend the spiral would be near the center of a 1-meter diameter main field of nominally 5 tesla. A mirror ratio of 1.2 or greater would keep these ions contained while the system was loaded with reactants.

An axial field gradient could also be used instead of injecting the ions at an angle. It would take only about a 5-degree gradient in a nominal 5 tesla main field to move the ions along the axis as the radial field gradient moved the spiral in. Gradients matched in this way would cause the spiral to leave the bend at nearly the center of the 1-meter diameter main field. The mirror would need to be spaced axially away from the injection location to allow the axial gradient in the bend to be this low. By using an axial gradient, the ions could be injected at a 90 degree angle to the axis of the main field. This results in the ions following much the same path as they chase each other and that results in more forward scattering during coulomb collisions. That forward scattering should keep many more of the scattered ions inside the walls of the tubular ion cloud.

The general design above would result in a 10-sided polygon with 10 bends available to incorporate injectors.

### Example Implementation 3

In another implementation, a polygon reactor incorporating bends for radial field gradients and straight sections may be used to act as magnetic mirror reactors.

For example, a reactor can be made in a ring configuration, somewhat like a storage ring. Multiple straight solenoid sections can be connected into a polygon. Ions are injected at the connections between straight sections of the reactor and then maintained in straight sections. Inside the connections between sections, the magnetic field lines are bent causing a higher field concentration on the inside of the bend compared to the outside. Ions looping in the magnetic field will drift to the inside of the bend due to the field gradient. Additionally, a field gradient can be added along the axis of the device, in the region of the bend. This gradient will cause the ions to move away from the bend as they are moving away from the injector. Once in the straight section, the ions are constrained from exiting the far end by the high field side of the next bend of the reactor.

This provides a way to load multiple magnetic mirrors with oriented ions that are easily retained inside the reactor. We could then begin to manipulate the mirrors. If we quickly move the maximum strength magnetic field regions in from the ends of the reactor, we would trap the ions between those mirrors and they would be swept ahead and into the ions being swept by the opposite mirror. This motion rapidly increases the ion density and the probability of a fusion collision. And it puts the high energy output region away from the ion injectors, protecting them from excessive thermal energy.

There will still be ions that escape the mirrors due to coulomb collisions changing their direction. These ions move more parallel to the main field lines. Multiple reactor sections connected in the ring-like structure maintain the low angle ions inside the reactor. The low angle ions spiral at a much smaller radius than the large angle ions. The smaller radius means that the difference in field across that radius is less. Therefore they drift more slowly towards the inside of the bend. They also only need a few revolutions inside the gradient to transit it. The low angle means they have high speed along the magnetic field lines. These low angle ions are still traveling fast enough that if they collide, they can fuse. They are not in the main cloud initially, but as the turns move them gradually inward, they will pass through the walls of the ion tube formed by the spiraling ions. They will then have a higher probability of a fusion collision due to the increased ion density of the tube wall. These collisions will be more orthogonal and less of a fast particle hitting a slow particle.

The field gradient along the axis at the bend has at least two functions. If one side of the bend has a high field compared to the field in the bend as well as to the field in the straight section, it provides a gradient to move the ions out of the bend. It also provides a mirror for the end of the neighboring straight section.

Ions looping in the magnetic field generate a magnetic field of their own. At ion densities high enough to get good fusion collision potential, the fields can be significant compared to the applied fields from the solenoid coils. They are also counter to the applied fields, canceling some of the solenoid coils effect. This changes the radius at which the ions then spiral.

The angle of the ion that you would like to be able to contain with the mirror determines the required magnetic field strength ratio between the low field region and the high field region. The ion cloud rotating in the lower field region between the high field mirrors counters some of the magnetic field generated by the solenoids there. And the high field at the center of the mirror excludes most of the ions from that region. Between the mirrors the effective field can be down to a few tesla while in the mirror it could be 35 or 40 tesla, resulting in a mirror ratio of perhaps 8. This would reflect ions traveling as close as 20 degrees from parallel to the main field.

For example, if the ion approaches the mirror moving along the magnetic field line, the mirror has almost no effect. If the ion approaches the mirror at a very high angle to the field lines, the mirror has a very strong effect. It is analogous to how a screw thread multiplies the force on a screw inversely proportional to its thread pitch. A basic reactor premise may be to have the ions travel a path that is nearly perpendicular to the magnetic field so that they are retained in a known position and can travel far enough along that path to have a high probability of a fusion collision. All while constraining the reactor to a reasonable physical size. Ions traveling at an angle less than 90 degrees to the field lines, and greater than the angle the mirrors will reflect, will continue to reflect back and forth between mirrors. In the example above, a coulomb collision resulting in an ion traveling at less than ˜20 degrees to the axis will enable that ion to leave the straight section to enter one or the other bend at the end of the straight section. But it will still follow the field lines to enter the next straight section allowing it to have another shot at a fusion collision. Ions at greater than ˜20 degrees will be reflected back toward the other mirror.

The design of the injector will balance the angle the ions are injected at compared to the local field lines against the along axis gradient and the radial gradient of magnetic fields. These will determine the position of the ion path inside the solenoid straight section. For example, perhaps the charged particles should be injected at a smaller angle, so that they will spiral out of the bend after just a few rotations.

Injectors would be needed for at least both reactant ions and enough electrons to generally neutralize the system. All could be positioned in each bend of the system. Once a sufficient number of ions had been injected, the high field regions at the mirrors could be swept towards each other trapping the injected ions between them. This sweeping motion compresses the trapped ions into higher and higher density the closer the mirrors move to each other. This higher density increases the probability of fusion reactions. It also results in a cyclic power output for the reactor, but injection can be continuous. The field in the straight section could be held at a modest strength as the ions fill the section. The coils at each end of the section are the strong field coils that generate the axial gradient through the bend. The compression would be started by increasing the field in the straight section coils right next to those coils. Once those coils are up to a higher field, the next coils closer to the center of the straight section could be brought up to high field. This moves the mirror ends closer to the center of the straight section, compressing the ion cloud trapped between them. Eventually the ions would be largely trapped between the two middle coils. The density there would then be high enough for fusion in a short time. While the mirrors are moving inward increasing the density of the ions, the counter field is increasing. To control the diameter of the ion tube, the field in the center region would also need to be ramped up. The example above would have an ion density of about 2.3e¹⁵ ions/cm³ and generate a counter field of about 30 tesla. The mirrors could be at 40 tesla separated by a distance that would allow the solenoid induced field to be about 35 tesla. The ions would travel a path defined by 5 tesla, the difference between the applied 35 and the induced 30.

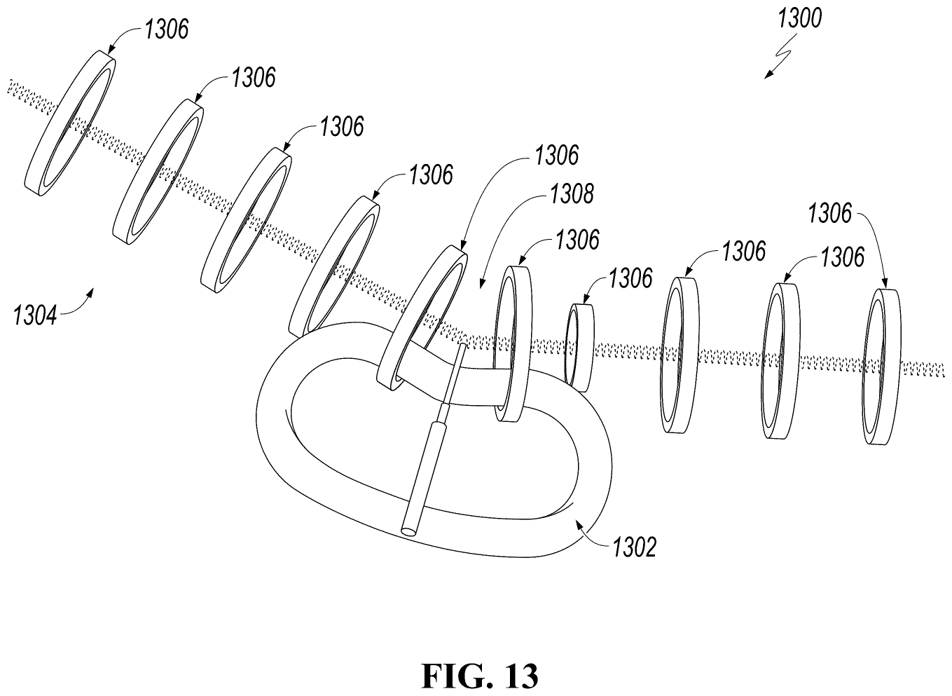

FIG. 13 shows an example of a bend portion 1300 of a reactor 1500. A small coil 1302, shown in FIG. 13 just to the right of the bend, forms the initial mirror for the right-hand straight section while it is also insuring a gradient to force the incoming charged particle to travel into the left had straight section 1304. The tubular shape at the bend is formed by winding superconducting wires 1306 primarily around a small diameter of the tubular shape. This then forms a closed magnetic field path inside the tubular shape. There is a gap 1308 in the tubular shape, configured to allow charged particles to pass through the region where the field from the torus counteracts the field in the coils. In some implementations, the magnetic field path is closed so that stray fields do not deflect the incoming ions in an undesirable way. The tubular shape can also be made from a series of coils, but the cross section of the windings is smaller for the continuous wrapped shape of the tubular shape shown. The coils retain their own magnetic field lines inside their closed path. The tubular shape is formed such that it also has a radial gradient in the field at the gap 1308. The gradient at the gap 1308 in the tubular would match the main reactor gradient at the gap in the tubular shape. [0086] The tubular shape may be eliminated and the angle between straight sections can be changed to accommodate other operating concepts.

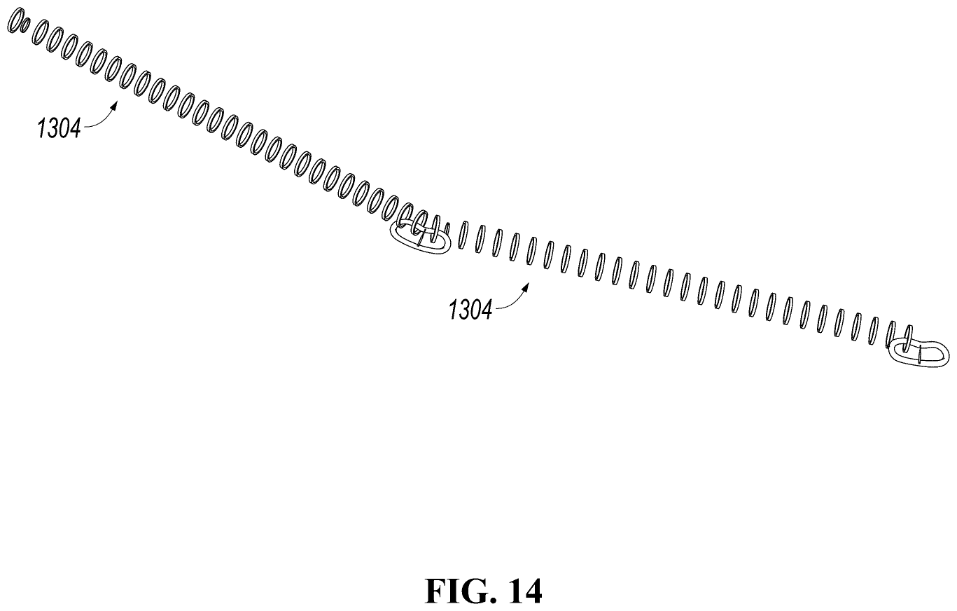

FIG. 14 shows two straight sections 1304 with a compression capability of substantially 25:1 (plus or minus 10%). The coils can remain stationary as the current in them changes during the movement of the mirrors to the center of the straight section, or they can be mechanically moved.

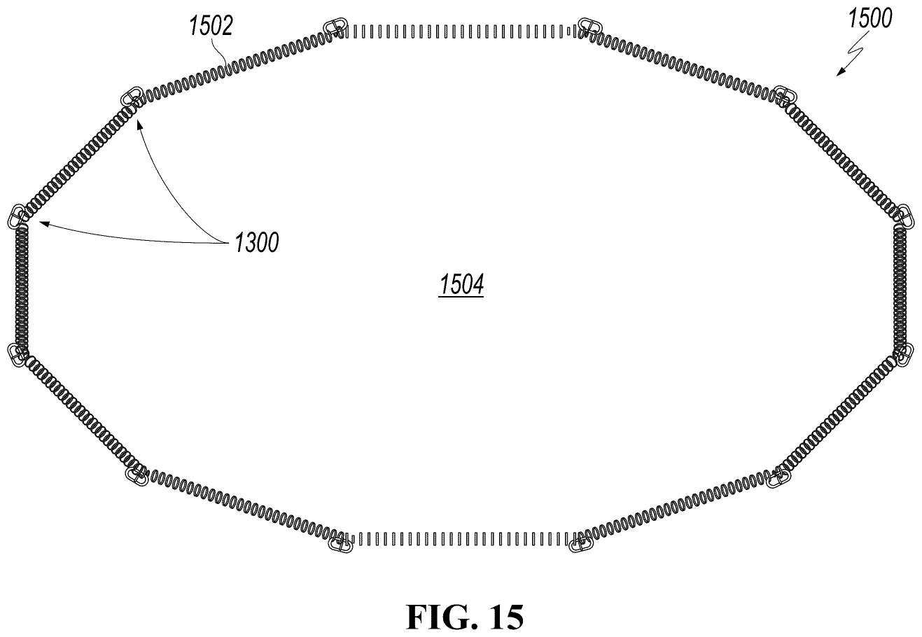

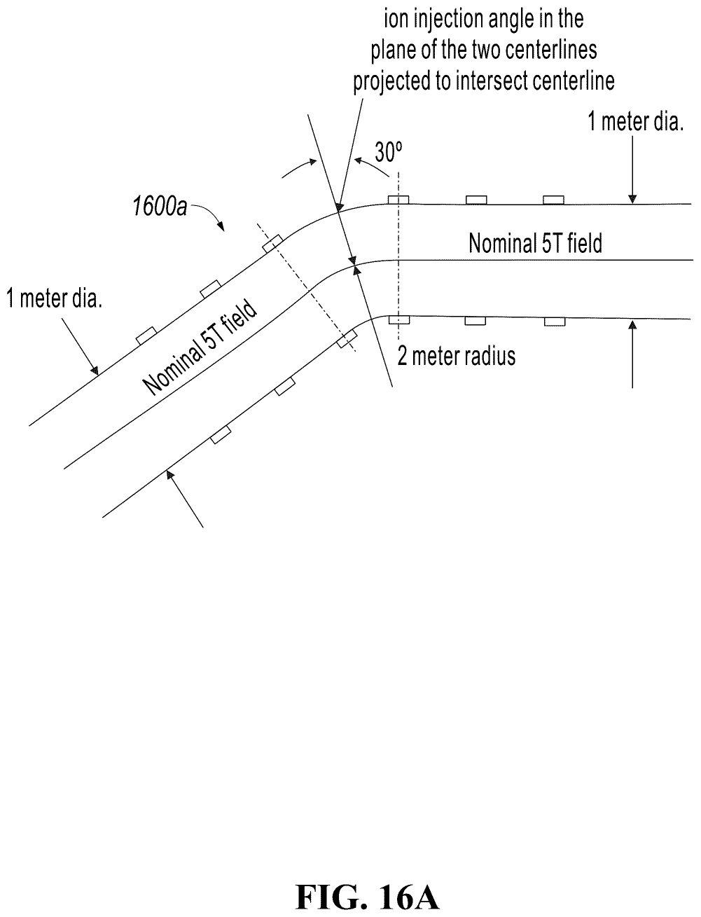

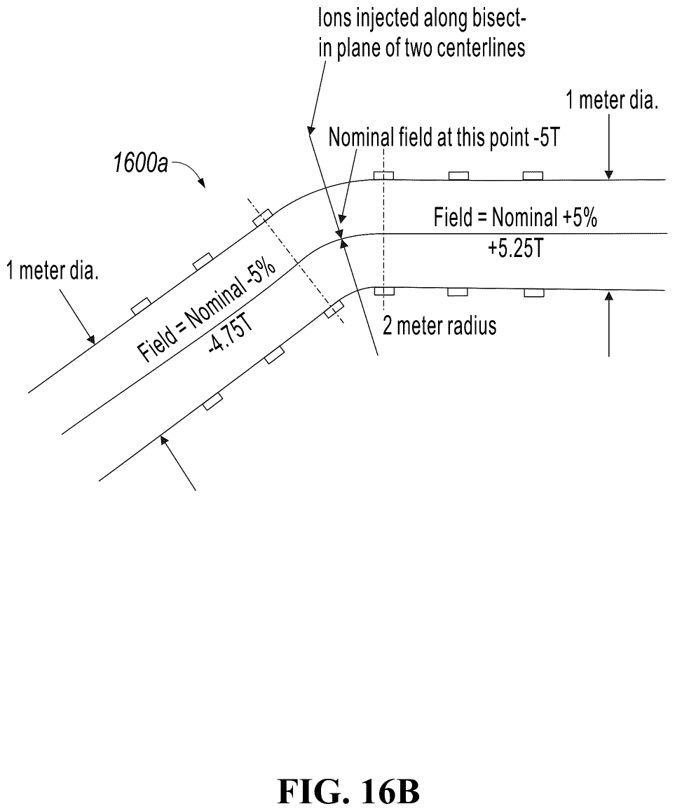

FIG. 15 is a perspective view a polygon-shaped reactor 1500 showing the closed loop of the reactor. The angle needed at each bend will determine the number of sides necessary to form a closed system. FIGS. 16A-16B show bend configurations 1600a and 1600b, respectively, and example field value that are applicable with the polygon-shaped reactor 1500 in some instances.

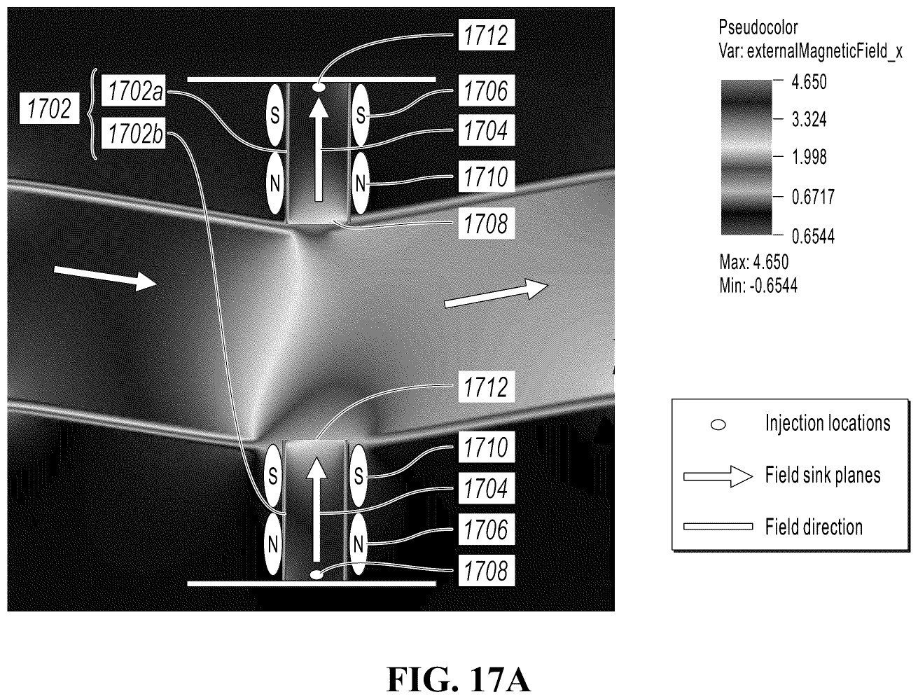

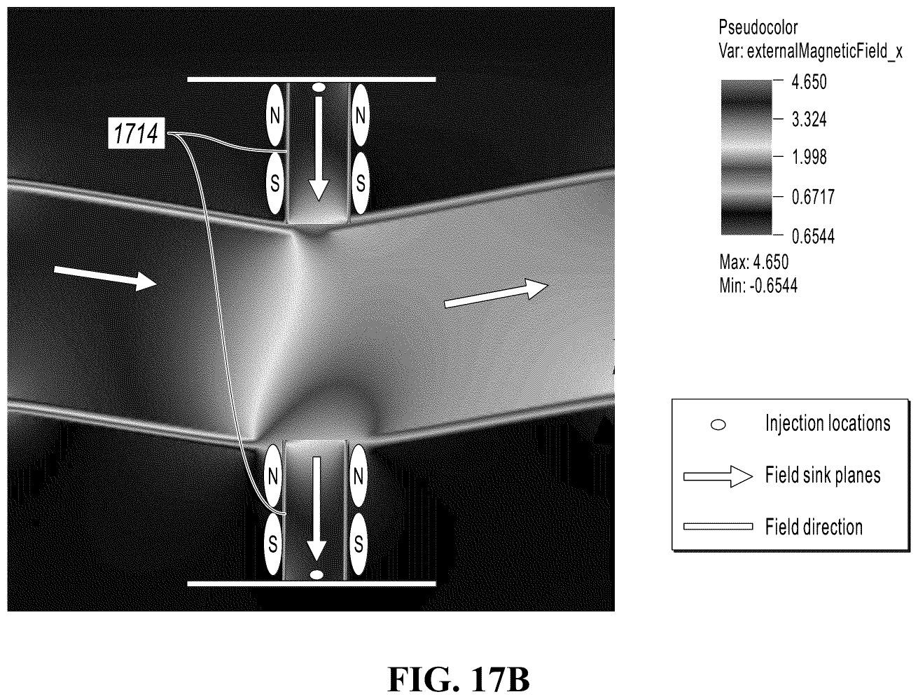

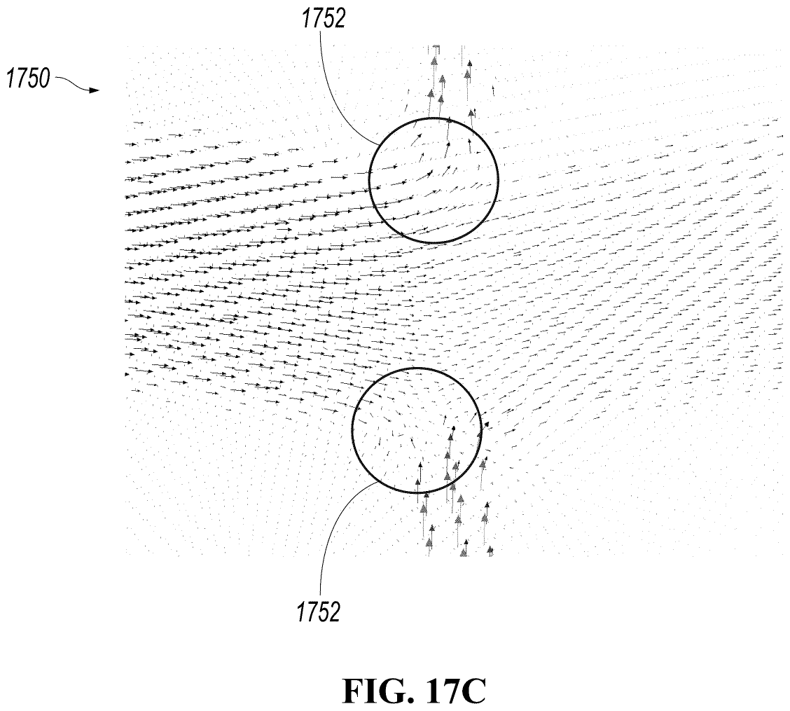

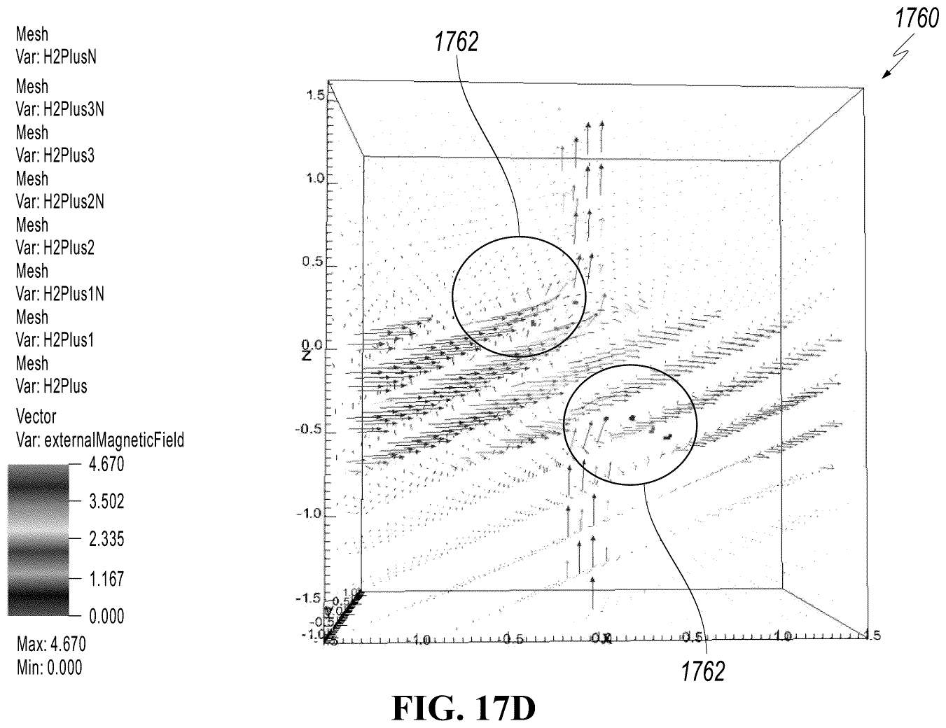

FIGS. 17A and 17B illustrate example ion injectors that can be used with aspects of this disclosure, for example the polygon-shaped reactor 1500. While primarily described and illustrated as being used with the polygon-shaped reactor 1500, the ion injectors described herein can be used with other fusion reactor arrangements, such as a tokamak, a magnetic mirror reactor, a stellarator, or any other fusion reactor arrangement without departing from this disclosure. FIG. 17A, illustrates a set of injectors 1702 with magnetic fields 1704 going from an outer perimeter 1502 of the polygon-shaped reactor 1500 towards a center 1504 of the polygon-shaped reactor 1500. In the illustrated example, the injectors 1702 are aligned to bisect two sections of the polygon-shaped reactor 1500 at the bend 1300. The injectors 1702 themselves have coupled magnetic generators in the form or permanent magnets or electromagnets, for example, a magnet 1706 with a S polarity arranged to be adjacent to an injection end 1708 of the inner injector 1702a and a N polarity arranged to be adjacent to an injection end 1708 of the outer injector 1702b. It then follows that a separate magnet 1710 would have a N pole arranged adjacent to an ejector 1712 of the inner injector 1702a with a S pole arranged adjacent to the ejector side 1712 of the outer injector 1702b.

FIG. 17B illustrates a set of injectors 1714 that is substantially similar to the injectors 1702 previously described with the exception of any differences described herein. The injectors 1714 define magnetic fields going from a center 1504 of the polygon-shaped reactor 1500 towards an outer perimeter 1502 of the polygon-shaped reactor 1500. As such, a magnetic arrangement opposite of the implementation illustrated in FIG. 17A is used. While primarily illustrated as horizontal injectors firing across the polygon-shaped reactor, other injection angles can be used without departing from this disclosure. For example, in some embodiments, a vertical injector arrangement can be used.

FIGS. 17C and 17D illustrate models of the magnetic injectors 1702. As can be seen from the model 1750 illustrated in FIG. 17C, the magnetic field lines from the injectors intersect smoothly with the magnetic field lines of the reactor 1500 at the circled intersections 1752. Model 1760 illustrated in FIG. 17D takes the model a step further in modeling particles 1762 representative of ion injection. As can be seen in the illustrated model, the particles do not reach the center of the reactor 1500 into the fusion zone; however, the model 1706 does show that ion injection with such an arrangement is feasible. Several solutions can address such concerns, for example, a narrower reactor can be used for successful injection into the fusion zone. Alternatively or in addition, changes in the magnetic field of the reactor, or other geometry changes to move the reaction zone nearer the injectors is feasible.

It is understood that the examples and implementation described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claim.

Additional non-limiting details relating to the current subject matter are discussed in the attached Appendices, Appendix A and Appendix B, which are also part of the current disclosure.

What is claimed is:

1. A fusion reactor comprising:
a vacuum chamber configured to contain a reaction region of spiraling ions and electrons;
a first injector configured to inject a first reactant ion species into the vacuum chamber;
a second injector configured to inject a second reactant ion species into the vacuum chamber;
a plurality of solenoid magnets configured to produce a magnetic field configured to control reactant ion motion in the vacuum chamber to overlapping spiral paths, wherein a velocity difference between ions of the first reactant ion species and ions of the second ion reactant species is sufficient to cause a fusion reaction between ions of the first reactant ion species and the second reactant ion species during a collision; and
a collection apparatus configured to harvest energy released during the fusion of ions of the first reactant ion species and the second reactant ion species.

2. The fusion reactor of claim 1, wherein the first reactant ion species is Boron, and the second reactant ion species is proton.

3. The fusion reactor of claim 2, wherein an energy of the Boron ion species is approximately 3.64e5 volts.

4. The fusion reactor of claim 2, wherein a voltage or voltages are chosen to generate a velocity difference of approximately 6.7e6 meters/sec between the Boron and proton.

5. The fusion reactor of claim 1, wherein the first reactant ion species is deuterium, and the second reactant ion species is deuterium.

6. The fusion reactor of claim 4, wherein the reactor is configured to react at least a portion of a product of an initial deuterium-deuterium reaction with the injected deuterium ions to form helium, hydrogen, and neutrons.

7. The fusion reactor of claim 1, wherein the fusion reactor is configured to collect energy from high energy helium ions, high energy protons, or high energy neutrons in a mix of direct and thermal energy extraction.

8. The fusion reactor of claim 1, wherein the fusion reactor is designed to collect energy from high energy helium ions, high energy protons, or high energy neutrons using thermal energy extraction.

9. The fusion reactor of claim 1, wherein the first reactant ion species is deuterium, and the second reactant ion species is Triton.

10. The fusion reactor of claim 1, wherein the first reactant ion species is Deuterium, and the second reactant ion species is ³He.

11. The fusion reactor of claim 1, further comprising a plurality of electron injectors, positioned to distribute electrons through the spiraling ions.

12. The fusion reactor of claim 1, further comprising an electron removal foil configured to be passed through a beam of the first reactant ion species at a velocity high enough to prevent overheating and charge crowding.

13. The fusion reactor of claim 1, wherein the first injector or the second injector comprise electrical and magnetic shields configured to provide electrical and magnetic shielding to the first reactant ion species and the second reactant ion species.

14. A method to cause ions to spiral on magnetic field lines within a fusion reactor, the method comprising:
injecting, by a first injector, a first reactant ion species into a vacuum chamber of the fusion reactor;
injecting, by a second injector, a second reactant ion species into the vacuum chamber, wherein the first reactant ion species and the second reactant ion species have overlapping spiral paths, and wherein energies are sufficient to cause an overtaking velocity sufficient to cause a fusion reaction between the first reactant ion species and the second reactant ion species;
sweeping the magnetic field lines relative to an injection line of the first reactant ion species and the second reactant ion species, wherein a high density ion species path is broadened; and
forming a magnetic field in a magnetic bottle, the magnetic bottle configured to constrain only the first reactant ion species and the second reactant ion species, and to allow a product ion species into an energy recovery module.

15. The method of claim 14, further comprising directing the product ion species, by electromagnetic plates within a low magnetic field region, into a direct electrical conversion module.

16. The method of claim 14, further comprising injecting electrons by electron injectors to distribute electrons through the spiraling ions.

17. The method of claim 16, wherein injecting electrons and injecting the first reactant ion species and the second reactant ion species comprises injecting at an angle relative to the magnetic field lines to ensure retention of spiraling ions due to a ratio of magnetic fields in a pinched region versus a reaction region.

18. The method of claim 14, wherein injecting by the first injector or the second injector comprises:
generating an injector magnetic field, by the first injector or the second injector, the injector magnetic field being opposite of a magnetic field within the vacuum chamber; and
generating a null zone at a tip of the first injector or the second injector by the injector magnetic field.
